(19) United States
(12) Patent Application Publication
(10) Pub. No.: US 2026/0230607 A1
(43) Pub. Date: Aug. 6, 2026

(54) CODING METHOD, DECODING METHOD, CODING APPARATUS, DECODING APPARATUS, CODER, DECODER, CODE STREAM AND STORAGE MEDIUM

(71) Applicant: GUANGDONG OPPO MOBILE TELECOMMUNICATIONS CORP., LTD., Dongguan (CN)

(72) Inventors: Yanzhuo MA, Dongguan (CN); Junyan HUO, Dongguan (CN); Fuzheng YANG, Dongguan, (CN); Nengfu QIU, Dongguan (CN); Jiaqi LIU, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/632,044

(22) Filed: Mar. 27, 2026

Related U.S. Application Data
(63) Continuation of application No. PCT/CN2023/123008, filed on Sep. 28, 2023.

(51) Int. Cl. H04N 19/11; H04N 19/105; H04N 19/117; H04N 19/132; H04N 19/147; H04N 19/156; H04N 19/176; H04N 19/593; H04N 19/70

(52) U.S. Cl. CPC H04N 19/11; H04N 19/105; H04N 19/117; H04N 19/132; H04N 19/147; H04N 19/156; H04N 19/176; H04N 19/593; H04N 19/70

(57) ABSTRACT

A coding method, a decoding method, a coding apparatus, a decoding apparatus, a coder, a decoder, a code stream and a storage medium provided in the embodiments of the present application, the decoding method comprising: according to a template of a current block, determining a prediction cost of a candidate prediction mode of the current block; according to the prediction cost, determining a first prediction mode of the current block; according to the first prediction mode, determining a reference template of the template; according to the reference template and the template, determining a first model parameter; and, according to the first prediction mode and the first model parameter, performing intra prediction on the current block to obtain a prediction value of the current block.

### CROSS-REFERENCE TO RELATED APPLICATIONS

This application is a continuation of International Application No. PCT/CN2023/123008, filed on Sep. 28, 2023, the disclosure of which is hereby incorporated by reference in its entirety.

### TECHNICAL FIELD

Embodiments of this application relate to video coding technologies, and relate to but are not limited to an encoding and decoding method and apparatus, an encoder, a decoder, a bitstream, and a storage medium.

### BACKGROUND

In the video coding field, how to enhance the video compression rate is important. In a digitalization process of an image and a video, a large quantity of data redundancy is generated, which makes a video compression technology possible. Because of strong similarity between adjacent blocks in a video image, an intra prediction method is used in a video coding technology to eliminate time redundancy between adjacent blocks, thereby improving a video compression rate. Practically, video coding and decoding performance for intra prediction is still to be enhanced in an existing video coding and decoding standard. Therefore, it is still significant to study how to further improve accuracy of intra prediction, so as to enhance video coding and decoding performance.

### SUMMARY

According to an encoding and decoding method and apparatus, an encoder, a decoder, a bitstream, and a storage medium that are provided in embodiments of this application, a predicted value of a current block is determined based on a first model parameter determined based on a template and a reference template of the template, so that intra prediction accuracy can be improved, thereby enhancing coding performance.

The video image processing method and apparatus, the encoder, the decoder, the bitstream, and the storage medium that are provided in embodiments of this application are implemented as follows.

According to a first aspect of embodiments of this application, a decoding method is provided. The method is applied to a decoder, and the method includes: determining a prediction cost of a candidate prediction mode of a current block according to a template of the current block; determining a first prediction mode of the current block according to the prediction cost; determining a reference template of the template according to the first prediction mode; determining a first model parameter according to the reference template and the template; and performing intra prediction on the current block according to the first prediction mode and the first model parameter, to obtain a predicted value of the current block.

According to a second aspect of the embodiments of this application, an encoding method is provided. The method is applied to an encoder, and the method includes: determining a prediction cost of a candidate prediction mode of a current block according to a template of the current block; determining a first prediction mode of the current block according to the prediction cost; determining a reference template of the template according to the first prediction mode; determining a first model parameter according to the reference template and the template; and performing intra prediction on the current block according to the first prediction mode and the first model parameter, to obtain a predicted value of the current block.

According to a third aspect of the embodiments of this application, a decoding apparatus is provided. The apparatus is applied to a decoder, and the apparatus includes: a first determining module, configured to determine a prediction cost of the candidate prediction mode of the current block according to a template of the current block; a second determining module, configured to determine a first prediction mode of the current block according to the prediction cost; a third determining module, configured to determine a reference template of the template according to the first prediction mode; a fourth determining module, configured to determine a first model parameter according to the reference template and the template; and a first prediction module, configured to perform intra prediction on the current block according to the first prediction mode and the first model parameter, to obtain a predicted value of the current block.

According to a fourth aspect of the embodiments of this application, a decoder is provided, including a first memory and a first processor. The first memory is configured to store a computer program runnable on the first processor; and the first processor is configured to: when running the computer program, execute the decoding method described in the embodiments of this application.

According to a fifth aspect of the embodiments of this application, an encoding apparatus is provided. The apparatus is applied to an encoder, and the apparatus includes: a fifth determining module, configured to determine a prediction cost of a candidate prediction mode of a current block according to a template of the current block; a sixth determining module, configured to determine a first prediction mode of the current block according to the prediction cost; a seventh determining module, configured to determine a reference template of the template according to the first prediction mode; an eighth determining module, configured to determine a first model parameter according to the reference template and the template; a second prediction module, configured to perform intra prediction on the current block according to the first prediction mode and the first model parameter, to obtain a predicted value of the current block.

According to a sixth aspect of the embodiments of this application, an encoder is provided, including a second memory and a second processor. The second memory is configured to store a computer program runnable on the second processor. The second processor is configured to: when running the computer program, execute the encoding method described in the embodiments of this application.

According to a seventh aspect of the embodiments of this application, a bitstream is provided, where the bitstream is obtained by using the encoding method described in the embodiments of this application.

According to an eighth aspect of the embodiments of this application, an electronic device is provided, including: a processor, configured to execute a computer program; and a computer readable storage medium, where the computer readable storage medium stores a computer program, and when the computer program is executed by the processor, the encoding method described in this embodiment of this application is implemented, or when the computer program is executed by the processor, the decoding method described in this embodiment of this application is implemented.

According to a ninth aspect of the embodiments of this application, a computer readable storage medium is provided, where the computer readable storage medium stores a computer program, and when the computer program is executed, the encoding method described in the embodiments of this application is implemented, or the decoding method described in the embodiments of this application is implemented.

It should be understood that the foregoing general description and the following detailed description are merely exemplary and explanatory, and are not intended to limit this application.

### BRIEF DESCRIPTION OF DRAWINGS

The accompanying drawings herein are incorporated into the specification and constitute a part of the specification. The accompanying drawings illustrate embodiments that conform to this application, and are used together with the specification to describe the technical solutions of this application. Apparently, the accompanying drawings in the following description show merely some embodiments of this application. A person of ordinary skill in the art may still derive other drawings from these accompanying drawings without creative efforts.

The flowchart shown in the accompanying drawings is merely an example illustration, and does not necessarily include all content and operations/steps, and the flowchart is unnecessary to be performed in the order described. For example, some operations/steps may be further decomposed, and some operations/steps may be combined or partially combined. Therefore, an actual execution order may be changed according to an actual situation.

FIG. 1 is a schematic block diagram of composition of an encoder according to an embodiment of this application.

FIG. 2 is a schematic block diagram of composition of a decoder according to an embodiment of this application.

FIG. 3 is a schematic diagram of a network architecture of an encoding and decoding system according to an embodiment of this application;

FIG. 4 is a schematic diagram of a prediction process of a TIMD technology according to an embodiment of this application;

FIG. 5 is a schematic diagram 1 of a template according to an embodiment of this application;

FIG. 6 is a schematic diagram 2 of a template according to an embodiment of this application;

FIG. 7 is a schematic diagram 3 of a template according to an embodiment of this application;

FIG. 8 is a schematic diagram of an available reference area of a TIMD technology according to an embodiment of this application;

FIG. 9 is a schematic flowchart of implementing an encoding method according to an embodiment of this application;

FIG. 10 is a schematic diagram of adjacent pixels of a current block according to an embodiment of this application;

FIG. 11 is a schematic flowchart of determining a prediction distortion value of a prediction mode in a candidate prediction mode of a current block according to an embodiment of this application;

FIG. 12 is a schematic diagram of a filtering model according to an embodiment of this application;

FIG. 13 is a schematic flowchart 1 of implementing step 905 according to an embodiment of this application;

FIG. 14 is a schematic flowchart 2 of implementing step 905 according to an embodiment of this application;

FIG. 15 is a schematic flowchart of implementing a decoding method according to an embodiment of this application;

FIG. 16 is a schematic flowchart of obtaining a predicted value in a TIMD-FLM mode according to an embodiment of this application;

FIG. 17 is a schematic diagram of TIMD-FLM prediction according to an embodiment of this application;

FIG. 18 is a schematic structural diagram of a decoding apparatus according to an embodiment of this application;

FIG. 19 is a schematic structural diagram of an encoding apparatus according to an embodiment of this application;

FIG. 20 is a schematic structural diagram of an encoder according to an embodiment of this application;

FIG. 21 is a schematic structural diagram of a decoder according to an embodiment of this application.

### DESCRIPTION OF EMBODIMENTS

To make the objectives, technical solutions, and advantages of the embodiments of this application clearer, the following further describes the specific technical solutions of this application in detail with reference to the accompanying drawings in the embodiments of this application. The following embodiments are used to describe this application, but are not intended to limit the scope of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following descriptions, the term “some embodiments” describes a subset of all possible embodiments, but it may be understood that “some embodiments” may be the same subset or different subsets of all possible embodiments and may be combined without a conflict.

It should be noted that the term “first\ second\ third” in embodiments of this application is used to distinguish between similar or different objects, and does not represent specific sorting for the objects. It may be understood that “first\ second\ third” may interchange a specific sequence or order when allowed, so that the embodiments described herein can be implemented in a sequence other than those shown or described herein.

The encoder and decoder frameworks and service scenarios described in the embodiments of this application are used to describe the technical solutions in the embodiments of this application more clearly, and do not constitute a limitation on the technical solutions provided in the embodiments of this application. It may be learned by a person of ordinary skill in the art that, with evolution of an encoder and a decoder and emergence of a new service scenario, the technical solutions provided in the embodiments of this application are also applicable to similar technical problems.

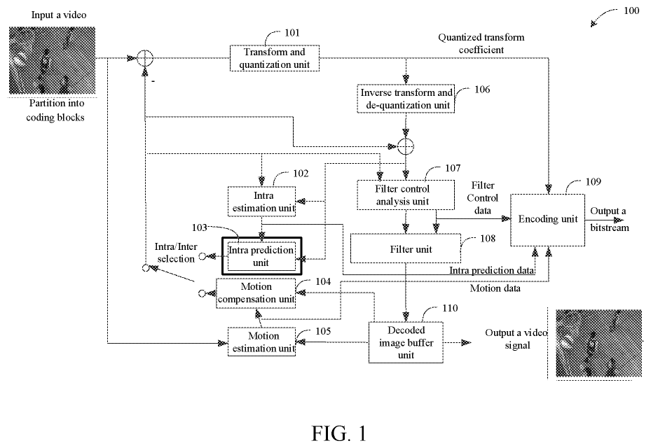

FIG. 1 shows a schematic diagram of composition of an encoder according to an embodiment of this application. As shown in FIG. 1, the encoder (specifically “video encoder”) 100 may include a transform and quantization unit 101, an intra-frame estimation unit 102, an intra prediction unit 103, a motion compensation unit 104, a motion estimation unit 105, an inverse transform and de-quantization unit 106, a filter control analysis unit 107, a filtering unit 108, an encoding unit 109, and a decoded image buffer unit 110. The filtering unit 108 may implement de-block filtering and sample adaptive offset (SAO) filtering, and the encoding unit 109 may implement header information coding and context-based adaptive binary arithmetic coding (CABAC). For an input original video signal, a video coding block may be obtained by means of division by using a Coding Tree Unit (CTU), and then residual sample information obtained after intra-frame or inter-frame prediction is transformed by using the transform and quantization unit 101 for the video coding block, including transforming residual information from a sample domain to a transform domain, and quantizing the obtained transform coefficient to further reduce a bit rate. The intra-frame estimation unit 102 and the intra prediction unit 103 are configured to perform intra prediction on the video coding block. Specifically, the intra-frame estimation unit 102 and the intra prediction unit 103 are configured to determine an intra prediction mode to be used to encode the video coding block. The motion compensation unit 104 and the motion estimation unit 105 are configured to perform inter-frame prediction coding of the received video code block relative to one or more blocks of the one or more reference frames to provide time prediction information. The motion estimated by the motion estimation unit 105 is a process of generating a motion vector, the motion vector may estimate the motion of the video coding block, and then the motion compensation unit 104 performs motion compensation based on the motion vector determined by the motion estimation unit 105. After the intra prediction mode is determined, the intra prediction unit 103 is further configured to provide the selected intra prediction data to the encoding unit 109, and the motion estimation unit 105 also transmits the calculated motion vector data to the encoding unit 109. In addition, the inverse transform and de-quantization unit 106 is configured to reconstruct the video coding block, reconstruct a residual block in a sample domain, and block effect artifact is removed from the reconstructed residual block by using the filter control analysis unit 107 and the filter unit 108, and then the reconstructed residual block is added to a prediction block in a frame of the decoded image buffer unit 110 to generate a reconstructed video coding block. The encoding unit 109 is configured to encode various encoding parameters and quantized transform coefficients. In a CABAC-based encoding algorithm, context content may be used to encode information indicating the determined intra prediction mode to output a bitstream of the video signal based on adjacent coding blocks. The decoded image buffer unit 110 is configured to store the reconstructed video coding block for prediction reference. As video image encoding proceeds, new reconstructed video coding blocks are continuously generated, and these reconstructed video coding blocks may be all stored in the decoded image buffer unit 110.

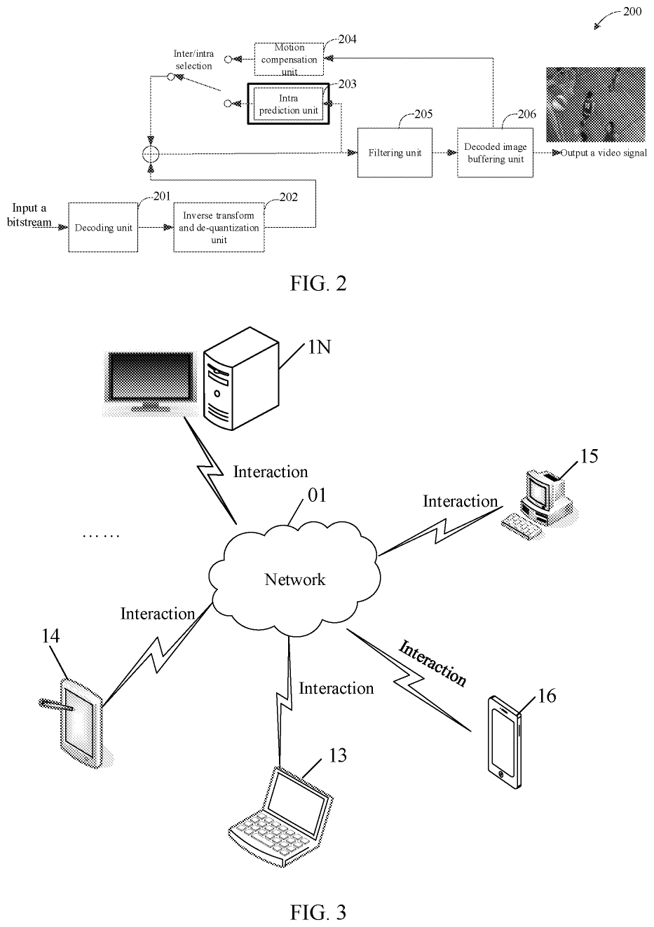

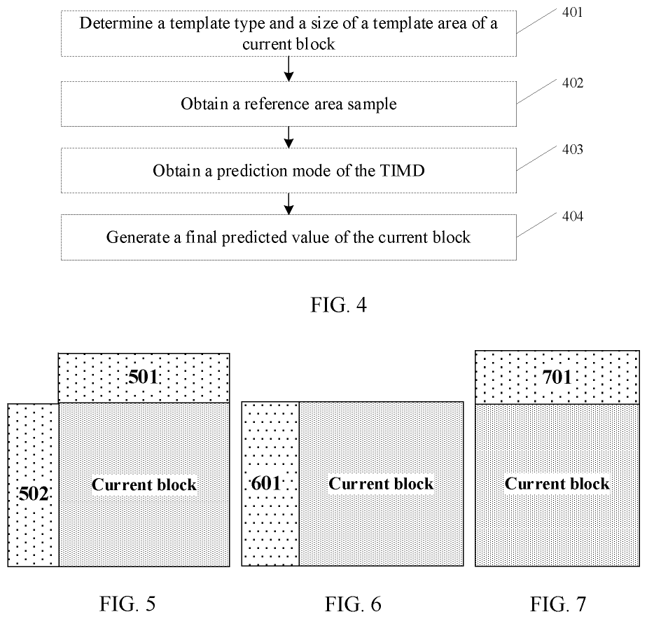

FIG. 2 shows a schematic diagram of composition of a decoder according to an embodiment of this application. As shown in FIG. 2, the decoder (specifically “video decoder”) 200 includes a decoding unit 201, an inverse transform and de-quantization unit 202, an intra prediction unit 203, a motion compensation unit 204, a filtering unit 205, and a decoded image buffer unit 206. The decoding unit 201 may implement header information decoding and CABAC decoding, and the filtering unit 205 may implement de-block filtering and SAO filtering. A bitstream of the video signal is outputted after an input video signal is subjected to encoding processing in FIG. 4A. The bitstream is inputted into the decoder 200, and the decoding unit 201 parses the bitstream to obtain a decoded transform coefficient. The transform coefficients are processed by the inverse transform and de-quantization unit 202, so that residual blocks are generated in the sample domain. The intra prediction unit 203 may be configured to generate prediction data of a current video decoding block based on the determined intra prediction mode and data from a previous decoded block of a current frame or picture. The motion compensation unit 204 determines prediction information for a video decoding block by parsing motion vectors and other associated syntax elements, and uses the prediction information to generate a prediction block of a video decoding block that is being decoded. A decoded video block is formed by adding a residual block from the inverse transform and de-quantization unit 202 and a corresponding predictive block generated by the intra prediction unit 203 or the motion compensation unit 204. The decoded video signal is processed by the filtering unit 205 to remove a block effect artifact, thereby improving video quality. The decoded video block is then stored in the decoded image buffer unit 206, and the decoded image buffer unit 206 stores a reference image that is used for subsequent intra prediction or motion compensation, and the decoded image buffer unit 206 is also configured to output the video signal, to obtain the recovered original video signal.

Further, an embodiment of this application further provides a network architecture of an encoding and decoding system including an encoder and a decoder. FIG. 3 shows a schematic diagram of a network architecture of an encoding and decoding system according to an embodiment of this application. As shown in FIG. 3, the network architecture includes one or more electronic devices 13 to 1N and a communications network 01, where the electronic devices 13 to 1N may perform video interaction with each other by using the communications network 01. In an implementation process, the electronic device may be various types of devices that have a video encoding and decoding function. For example, the electronic device may include a smartphone, a tablet computer, a personal computer, a personal digital assistant, a navigator, a digital telephone, a video telephone, a television, a sensing device, and a server. This is not specifically limited herein. In addition, the decoder or encoder in embodiments of this application may be the foregoing electronic device.

It should be noted that the method in embodiments of this application is mainly applied to the intra prediction unit 103 shown in FIG. 1 and the intra prediction unit 203 shown in FIG. 2. That is, embodiments of this application may be applied to either an encoder or a decoder, or may even be applied to both an encoder and a decoder. However, embodiments of this application set no specific limitation thereto.

It should be further noted that when applied to the intra prediction unit 103, the “current block” specifically refers to a coding block on which currently intra prediction is to be performed, that is, a current coding block. When applied to the intra prediction unit 203, the “current block” specifically refers to a decoding block on which currently intra prediction is to be performed, that is, a current decoding block.

To facilitate understanding of solutions such as the encoding method and the decoding method described in the embodiments of this application, a template based intra mode derivation (TIMD) process is first described. TIMD is an intra prediction mode that can be used for luminance or chrominance, and the encoder and decoder perform the same operation to obtain a final predicted value. Specifically, for an intra prediction mode in a given prediction mode set (for example, an MPM list), a predicted value of the template is calculated for the template of the current block according to the mode, a predicted value of the template is compared with a reconstruction value of the template to calculate a prediction cost (for example, an absolute transformation difference (SATD)), and a specific quantity (for example, one or two) of prediction modes are selected according to a size of the prediction cost to perform intra prediction on the current block. For example, it is assumed that a prediction mode with minimum SATD is Mode1, and SATD of the prediction mode is costMode1; a prediction mode with a second minimum SATD is Mode2, and SATD of the prediction mode is costMode2. It is determined whether to apply weighted fusion according to the size of costMode1 and costMode2.

If costMode2<2*costMode1, weighted fusion is performed on the predicted values of the current block that are obtained by prediction by using the Mode1 and the Mode2, and the weighted result is used as the final predicted value of the current block.

Otherwise, only Mode1 is used to calculate the final predicted value of the current block.

The following describes the prediction process of the TIMID technology in detail.

Input of TIMD: location of the current block (xTbCmp, yTbCmp), width uiWidth of the current block, and height uiHeight of the current block.

Output of TIMD: The predicted value of the current block is predSamples[x][y], where x=0 . . . nTbW−1, y=0 . . . nTbH−1.

As shown in FIG. 4, a specific prediction process of the TIMID technology includes the following steps 401 to 404.

In step 401, a template type and a size of a template of a current block are determined.

In step 402, a reference area sample is obtained.

In step 403, a prediction mode of the TIMID is obtained.

In step 404, a final predicted value of the current block is generated.

After the foregoing process, a predicted value of the current block may be obtained.

The following describes in detail.

In step 401, a current template type and size are determined.

The templates available in the TIMID technology include an upper adjacent reconstructed sample area and a left adjacent reconstructed sample area. The template type (eTempType) is determined according to a location of the current block. For example:

If both the left and upper adjacent reconstructed pixels are unavailable, eTempType is NO_NEIGHBOR, and there is no template.

If both the left and upper adjacent reconstructed samples are available, eTempType is LEFT_ABOVE_NEIGHBOR, and the template is 501 and 502 as shown in FIG. 5.

If only the left adjacent reconstructed samples are available, eTempType is LEFT_NEIGHBOR, and the template is 601 shown in FIG. 6.

If only the upper adjacent reconstructed samples are available, eTempType is ABOVE_NEIGHBOR, and the template is 701 shown in FIG. 7.

The template size of the template used by the TIMD technology is related to the current block size. For example:

If the height (uiHeight) of the current block is greater than or equal to 8, the template height (iTempHeight) is 4; otherwise, the template height is 2.

If the width (uiWidth) of the current block is greater than or equal to 8, the template width (iTempWidth) is 4; otherwise, the template width is 2.

In step 402, a reference area sample is obtained.

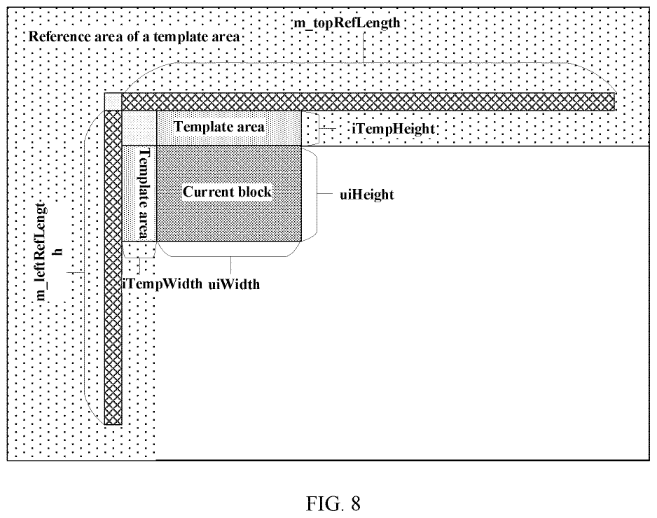

As shown in FIG. 8, the reference areas available in the TIMD technology include adjacent reconstructed sample areas on the left and upper sides of the template. It is assumed that a length of a left adjacent reconstructed sample area is m_leftRefLength, and a length of an upper adjacent reconstructed sample area is m_topRefLength,

$$m\_leftRefLength = ( uiHeight + iTempHeight ) << 3$$

$$m\_topRefLength = ( uiWidth + iTempWidth ) << 3$$

In step 403, a prediction mode of the TIMID is obtained.

To obtain the prediction mode of the TIMID, first, a prediction mode set needs to be obtained. Then, the prediction mode set is traversed to calculate the predicted value for the template. The prediction mode of the TIMD is selected for the current block by calculating the prediction cost.

In the TIMD technology, the encoder or decoder selects a prediction mode set according to a prediction mode of an adjacent block (left, lower left, upper right, upper, upper left) of the current block.

If an angle prediction mode does not exist for an adjacent block, the prediction mode set includes a Planar mode and/or a DC mode.

If an angle prediction mode exists for an adjacent block, the prediction mode set includes an MPM list and a wide angle prediction mode. If there is no DC/HOR/VER mode in the MPM list, DC/HOR/VER mode is added at the end of the MPM list.

At step 404, a final predicted value of the current block is generated.

(1) If the prediction mode set includes only the Planar mode and/or the DC mode, after the prediction mode set is traversed in the template, a mode with a minimum prediction cost (iBestMode) is selected as the prediction mode of the TIMD, and weighted fusion is not performed. That is, predSamples[x][y] is directly obtained by using a corresponding method of the selected TIMD prediction mode, where x=0, . . . , nTbW−1, y=0, . . . , nTbH−1.

### (2) Otherwise,

if there is only one prediction mode in the prediction mode set, weighted fusion is not performed, and prediction is performed on a current block by using the prediction mode to obtain a final predicted value. That is, predSamples[x][y] is directly obtained by using a corresponding method of the prediction mode, where x=0, . . . , nTbW−1, y=0, . . . , nTbH−1.

If there is more than one prediction mode in the prediction mode set, after the prediction mode set is traversed in the template, a mode with a minimum prediction cost (iBestMode) and a mode with a second minimum prediction cost (iSecondaryMode) are obtained. Then, adjacent angle modes (+1 and −1) of the iBestMode and the iSecondaryMode are checked and updated as prediction modes of the TIMD, and prediction costs of the four adjacent angle modes for the template are determined. Based on this, a mode with a minimum prediction cost (still indicated as iBestMode, that is, updated iBestMode) and a mode with a second minimum prediction cost (still indicated as iSecondaryMode, that is, updated iSecondaryMode) are determined from the iBestMode, the adjacent angle modes (+1 and −1) of the iBestMode, the iSecondaryMode, and the adjacent angle modes (+1 and −1) of the iSecondaryMode. It is assumed that prediction costs of iBestMode and iSecondaryMode are respectively uiBestCost and uiSecondaryCost.

In the TIMD technology, the encoder or decoder determines whether to apply weighted fusion according to the size ofuiBestCost and uiSecondaryCost. Details are as follows:

If uiSecondaryCost>=2*uiBestCost, weighted fusion is not applied, and the current block is predicted by using iBestMode, to obtain a final predicted value.

If uiSecondaryCost<2*uiBestCost, weighted fusion is applied. It is assumed that a weight of iBestMode is weight1, and a weight of iSecondaryMode is weight2. Details are as follows:

$$weight 1 = uiSecondaryCost / ( uiBestCost + uiSecondaryCost )$$

$$weight 2 = 1 - weight 1$$

Two predicted values (pelPred[x][y] and pelPredFusion[x][y], where x=0 . . . nTbW−1, y=0 . . . nTbH−1) of the current block are obtained by using iBestMode and iSecondaryMode. Then, weighted fusion is applied to obtain a final predicted value predSamples[x][y]. Details are as follows:

$$predSamples [ x ] [ y ] = pelPred [ x ] [ y ] * weight 1 + pelPredFusion [ x ] [ y ] * weight 2$$

Template-based Intra Mode Derivation (Template based Intra Mode Derivation) is an intra prediction mode that can be used for luminance or chrominance. The encoder and the decoder perform the same operation to obtain the final predicted value. Specifically, for an intra prediction mode in a given prediction mode set (for example, an MPM list), a template prediction value is calculated for a template of a current block according to the mode, a template prediction value is compared with a template reconstruction value to calculate a prediction cost (for example, an sum of absolute transformation difference (SATD)), a specific quantity (for example, one or two) of prediction modes are selected according to a size of the prediction cost, and a best or best and second best modes are obtained according to a size of the SATD, to calculate a final predicted value of the current block.

However, information of the reconstructed adjacent sampling point cannot be fully utilized in the non-merge prediction mode and the merge prediction mode. If availability determining is performed on all search points in the entire to-be-determined reconstruction area, encoding complexity is increased.

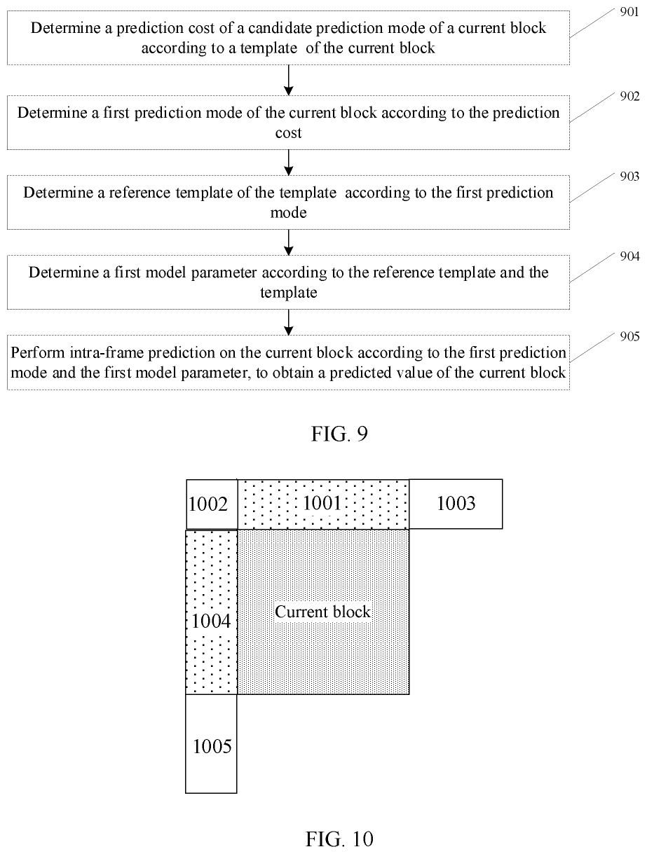

Based on the foregoing analysis, an embodiment of this application provides an encoding method. The method may be applied to the encoder 100 shown in FIG. 1. FIG. 9 is a schematic flowchart of implementation of the encoding method according to an embodiment of this application. As shown in FIG. 9, the method includes the following steps 901 to 905.

In step 901, a prediction cost of a candidate prediction mode of a current block is determined according to a template of the current block.

In step 902, a first prediction mode of the current block is determined according to the prediction cost.

In step 903, a reference template of the template is determined according to the first prediction mode.

In step 904, a first model parameter is determined according to the reference template and the template.

In step 905, intra prediction is performed on the current block according to the first prediction mode and the first model parameter, to obtain a predicted value of the current block.

In embodiments of this application, after the first prediction mode of the current block is obtained based on the template of the current block, intra prediction is not performed on the current block directly based on the first prediction mode. The following operations are performed: a reference template of the template is determined based on the first prediction mode; a first model parameter is determined based on the reference template and the template; and intra prediction is performed on the current block based on the first prediction mode and the first model parameter, to obtain a predicted value of the current block. In this way, a predicted value of the current block is determined based on the first model parameter determined based on a template and a reference template of the template, so that intra prediction accuracy can be improved, thereby saving a bit rate.

The following separately describes optional implementations of the foregoing steps and related nouns.

In step 901, a prediction cost of the candidate prediction mode of the current block is determined according to the template of the current block.

In some embodiments, the template of the current block may be determined as follows: the template of the current block is determined according to adjacent samples of the current block.

For example, in some embodiments, an adjacent sample of the current block includes at least one of the following:

an upper adjacent sample of the current block, for example, an area 1001 shown in FIG. 10;

an upper left adjacent sample of the current block, such as an area 1002 shown in FIG. 10;

an upper right adjacent sample of the current block, such as an area 1003 shown in FIG. 10;

a left adjacent sample of the current block, such as an area 1004 shown in FIG. 10; or

a lower left adjacent sample of the current block, such as an area 1005 shown in FIG. 10.

In some embodiments, the template of the current block includes available samples in adjacent samples of the current block. It may be understood that available samples in adjacent samples refer to samples that have been reconstructed in adjacent in adjacent pixels.

In some embodiments, the encoder or decoder may determine the size of the template based on the size of the current block.

For example, if the height of the current block (uiHeight shown in FIG. 8) is greater than or equal to 8, the height of the template (iTempHeight shown in FIG. 8) is 4; otherwise, the height of the template is 2.

If the width of the current block (uiWidth shown in FIG. 8) is greater than or equal to 8, the width of the template (iTempWidth shown in FIG. 8) is 4; otherwise, the width of the template is 2.

In embodiments of this application, the candidate prediction mode of the current block may include one or more prediction modes, and the candidate prediction mode of the current block may also be understood as the prediction mode set mentioned in this specification. The prediction cost includes a prediction distortion value corresponding to the one or more prediction modes.

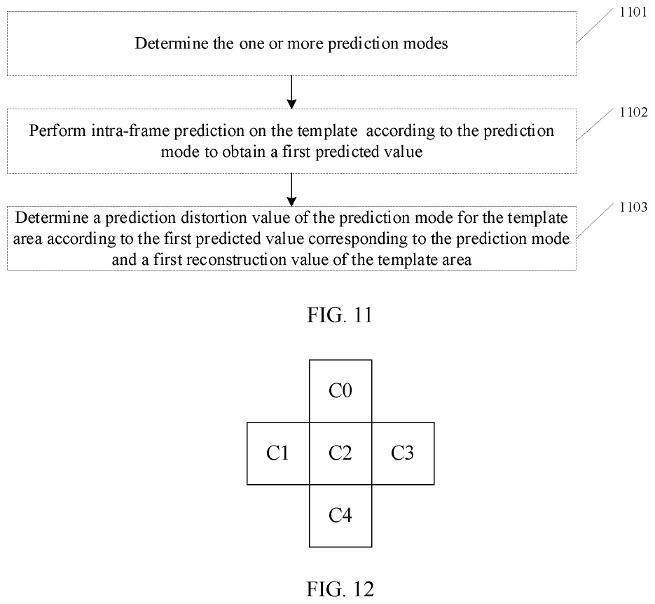

In some embodiments, as shown in FIG. 11, the encoder or decoder may determine the predicted distortion value of the prediction mode in the candidate prediction mode of the current block by using the following steps 1101 to 1103.

In step 1101, the one or more prediction modes are determined.

In some embodiments, the encoder or decoder may implement step 1101 as follows: determining the one or more prediction modes according to a second prediction mode used to perform intra prediction on adjacent blocks of the current block.

In embodiments of this application, second prediction modes of adjacent blocks of the current block that are selected as candidate prediction modes of the current block are not limited.

For example, in some embodiments, one or more second prediction modes with minimum prediction distortion may be selected as candidate prediction modes of the current block, based on the prediction distortion error/cost of the second prediction mode of the adjacent block of the current block for the template of the current block.

For another example, in other embodiments, a candidate prediction mode of a current block may also be selected as follows:
in a case that the second prediction mode includes no angular prediction mode, the one or more prediction modes (that is, a candidate prediction mode of a current block) includes a Planar mode and/or a DC mode;
in a case that the second prediction mode includes an angular prediction mode, the one or more prediction modes (that is, a candidate prediction mode of a current block) include a prediction mode in an MPM list of a current block constructed according to the adjacent block information, and the prediction mode may include a wide angle prediction mode.

Further, in some embodiments, when the MPM list does not include a third prediction mode, the third prediction mode is added to the MPM list.

For example, in some embodiments, the third prediction mode includes a DC mode, an HOR mode, and/or a VER mode.

In some embodiments, an adjacent block of a current block includes a reconstructed block adjacent to the current block. For example, in some embodiments, the adjacent block includes at least one of the following:
a left adjacent block of the current block;
a lower left adjacent block of the current block;
an upper right adjacent block of the current block;
an upper adjacent block of the current block;
an upper left adjacent block of the current block.

In step 1102, intra prediction is performed on the template according to the prediction mode to obtain a first predicted value.

In step 1103, a prediction distortion value of the prediction mode for the template is determined according to a first predicted value corresponding to the prediction mode and a first reconstruction value of the template.

It may be understood that a prediction distortion value of the prediction mode for the template refers to an intra prediction error of the prediction mode for the template. For example, in some embodiments, the encoder or decoder may determine the SAD (sum of absolute difference), SSE (Sum of Squares due to Error), SATD (sum of absolute transformed difference), MSE (mean-square error), etc., between the first predicted value predicted by using the prediction mode for the template region and the first reconstructed value of the template, thereby obtaining the predicted distortion value/predicted distortion cost/intra prediction error of the prediction mode. That is, the SAD, the SSE, the SATD, or the MSE are used to represent the predicted distortion value of the prediction mode. A smaller SAD, SSE, SATD, or MSE indicates a smaller predicted distortion value, that is, a smaller intra prediction error.

In step 902, the first prediction mode of the current block is determined according to the prediction cost.

In some embodiments, the first prediction mode is one or more prediction modes selected from the candidate prediction modes.

For example, in some embodiments, the first prediction mode includes a prediction mode with a minimum prediction cost in the candidate prediction mode.

In step 903, the reference template of the template is determined according to the first prediction mode.

As mentioned above, in some embodiments, the first prediction mode includes a prediction mode with a minimum prediction cost in the candidate prediction mode. Based on this, in some embodiments, the encoder or decoder may determine the reference template of the template according to the prediction mode with the minimum prediction cost.

In step 904, the first model parameter is determined according to the reference template and the template.

In some embodiments, the first model parameter includes a filtering coefficient of the target filtering model. In embodiments of this application, a shape of the target filtering model and a quantity of filtering coefficients (that is, a quantity of taps of the filtering model) are not limited. A shape of the target filtering model may be a m1*m2 matrix, where m1 is greater than 0, m2 is greater than 1, or m1 is greater than 1, and m2 is greater than 0. The shape of the target filtering model may also be cross-shaped, for example, as shown in FIG. 12, where C0-C4 represent filtering coefficients at different locations.

The quantity of taps of the target filtering model is defined as nTap. nTap may be a constant, or may be a variable, for example, the quantity of taps of the filtering model may be dynamically adjusted according to a size of a current block. In some embodiments, the encoder may select filtering models of multiple shapes.

In some embodiments, the encoder or decoder may determine a first model parameter as follows: the first model parameter is determined according to a sample reference value in the reference template and a sample reference value in the template region.

Further, in some embodiments, the process of determining the first model parameter according to the sample reference value of the reference template and the sample reference value of the template includes:
determining an autocorrelation parameter according to the sample reference value in the reference template;
determining a cross-correlation parameter according to the sample reference value in the template and the sample reference value in the reference template; and
determining the first model parameter according to the autocorrelation parameter and the cross-correlation parameter.

For example, in some embodiments, the pixel reference value includes at least one of a sample reconstruction value, a pixel gradient value of the sample reconstruction value, and sample location information.

In Example 1, the encoder or decoder may construct an MSE between the sample reference value of the reference template and the sample reference value of the template region according to the following formula, and the first model parameter is determined based on the MSE:

$$MSE = E [ {( predTemp [ i ] [ j ] - recTemp [ i ] [ j ] )}^{2} ] = E [ {( {\sum }_{k , l = - 1 \sim 1} {c}_{k , l} \cdot refTemp [ i + k ] [ j + l ] - recTemp [ i ] [ j ] )}^{2} ]$$

In which, refTemp[i][j] represents a sample reference value of the reference template, recTemp[i][j] represents a sample reference value of the template, (i, j) represents a coordinate position, (i, j)∈R, k, l represent a coordinate offset of the filter coefficient position relative to a center position of the filter model. The filtering model shown in FIG. 12 is used as an example, where k and l are between −1 and 1, and values of (k, l) include (0, 0), (0, −1), (−1, 0), (0, 1), (1, 0), and (1, 0), C_{k, l} indicating a required filtering coefficient, and E represents an operation for calculating an average value. The calculation formula is as follows:

$$MSE = \frac{1}{{N}_{pos}} {\sum }_{i} {\sum }_{j} {\vert predTemp [ i ] [ j ] - recTemp [ i ] [ j ] \vert}^{2}$$

Where Nₚₒₛ refers to a quantity of (i, j) pairs participating in calculating |predTemp[i][j]−recTemp[i][j]|².

A process of minimizing MSE to derive the filtering coefficient is specifically as follows:

1) First, calculating a partial derivative of c_{k,l} and let the partial derivative to be equal to 0:

$$\frac{\partial MSE}{\partial {c}_{m}} = E \text{} [ 2 ( {\sum }_{k , l = - 1 \sim 1} {c}_{k , l} \cdot refTemp [ i + k ] [ j + l ] - recTemp [ i ] [ j ] ) \cdot refTemp [ i + m ] [ j + n ] ]$$

$$where m and n are between - 1 and 1 ;$$

$$E [ 2 ( {\sum }_{k , l = - 1 \sim 1} {c}_{k , l} \cdot recTemp [ i + k ] [ j + l ] - recTemp [ i ] [ j ] ) \cdot recTemp [ i + m ] [ j + n ] ] = 0 ,$$

$$summing up :$$

$$= {\sum }_{k , l = - 1 \sim 1} {c}_{k , l} \cdot E ( refTemp [ i + k ] [ j + l ] \cdot recTemp [ i + m ] [ j + n ] ) = E ( recTemp [ i ] [ j ] \cdot refTemp [ i + m ] [ j + n ] )$$

2) After the reference template and the corresponding reference template are determined, the equation obtained in step 1) is expanded into a matrix form:

$$[ \begin{matrix}E ( refTemp [ i ] [ j ] \cdot refTemp [ i ] [ j ] ) & E ( refTemp [ i - 1 ] [ j ] \cdot refTemp [ i ] [ j ] ) & ⋯ & E ( refTemp [ i ] [ j + 1 ] \cdot refTemp [ i ] [ j ] ) \\ E ( refTemp [ i ] [ j ] \cdot refTemp [ i - 1 ] [ j ] ) & E ( refTemp [ i - 1 ] [ j ] \cdot refTemp [ i - 1 ] [ j ] ) & ⋯ & E ( refTemp [ i ] [ j + 1 ] \cdot refTemp [ i - 1 ] [ j ] ) \\ ⋮ & ⋮ & ⋱ & ⋮ \\ E ( refTemp [ i ] [ j ] \cdot refTemp [ i ] [ j + 1 ] ) & E ( refTemp [ i - 1 ] [ j ] \cdot refTemp [ i ] [ j + 1 ] ) & ⋯ & E ( refTemp [ i ] [ j + 1 ] \cdot refTemp [ i ] [ j + 1 ] )\end{matrix} ] \cdot [ \begin{matrix}{c}_{0 , 0} \\ {c}_{- 1 , 0} \\ ⋮ \\ {c}_{0 , 1}\end{matrix} ] = [ \begin{matrix}{\sum }_{i ∈ R} ( recTemp [ i ] [ j ] \cdot refTemp [ i ] [ j ] ) \\ {\sum }_{i ∈ R} ( recTemp [ i ] [ j ] \cdot refTemp [ i - 1 ] [ j ] ) \\ ⋮ \\ {\sum }_{i ∈ R} ( recTemp [ i ] [ j ] \cdot refTemp [ i ] [ j + 1 ] )\end{matrix} ]$$

3) The autocorrelation matrix of the refTemp and the cross-correlation vectors of the refTemp and the recTemp in the reference template in step 2) are all known. A filtering coefficient c_{k,l} may be obtained by solving the equations in step 2), and the filtering coefficient c_{k,l} may be fixed or not.

In a process of solving the linear equation group, an autocorrelation matrix of the reconstructed sample refTemp in the reference template is first calculated, a cross-correlation vector of the refTemp and the reconstructed sample recTemp in the template is then calculated, Cholesky decomposition or LDL decomposition is performed on the autocorrelation matrix, and finally, each filtering coefficient Cₙ is sequentially calculated by recursion, and the group of filtering coefficients may be fixed or not.

In the foregoing example 1, a linear filtering model is established based on the sample reference value of the template and the sample reference value of the reference template. In the example 2, a nonlinear filtering model between the sample reference value of the template and the sample reference value of the reference template may also be established.

In an implementable manner, a quadratic term is introduced to establish a nonlinear filtering model, for example:

When the MSE of the filtering coefficient is minimized in Example 1, the calculation method is changed to the following equation:

$$\begin{matrix}MSE = E [ {( predTemp [ i ] [ j ] - recTemp [ i ] [ j ] )}^{2} ] \\ = E [ {( {\sum }_{k , l = - 1 \sim 1} {c}_{k , l} \cdot {( refTemp [ i + k ] [ j + l ] )}^{2} - recTemp [ i ] [ j ] )}^{2} ]\end{matrix}$$

The method for calculating the predicted value is changed as follows:

$${Y}^{pred} [ i ] [ j ] = {\sum }_{k} {\sum }_{l} {( ref [ i + k ] [ j + l ] )}^{2} \times {C}_{, k , l}$$

In which, ref[i+k][j+l] represents an input sample value of a position corresponding to the filter coefficient. If the position corresponding to the filter coefficient is outside the current block, the sample reconstruction value at the position may be used as the input sample value. If the position corresponding to the filter coefficient is within the current block, the pixel prediction value at the position may be used as the input pixel value.

In some embodiments, when a part of input position of the target filtering model corresponding to the first model parameter exceeds the reference template or template, the reference template or template is filled with a sample reference value corresponding to the part of input position.

In some embodiments, the reference template or the template is filled with a sample reference value corresponding to the part of input location, if at least one of the following conditions is met:
a sample position corresponding to the part of input position is already reconstructed;
the part of input position does not exceed a boundary of a current image; or
the part of input position does not exceed a Tile boundary.

Certainly, in other embodiments, when a part of input location of the target filtering model corresponding to the first model parameter exceeds the reference template, the part of input location may not participate in determining the first model parameter.

In embodiments of this application, the encoder may establish only one linear filtering model to determine the first model parameter, or the encoder may establish multiple linear filtering models to determine multiple groups of candidate filtering coefficients, and then select one group of filtering coefficients as the first model parameter.

In some embodiments, the first model parameter includes a filtering coefficient of a target filtering model. The encoder may determine the first model parameter as follows:
determining a first candidate filtering coefficient of the target filtering model according to a sample reference value of a first-type sample in the reference template and a sample reference value of a first-type sample in the template;
determining a second candidate filtering coefficient of the target filtering model according to a sample reference value of a second-type sample in the reference template and a sample reference value of a second-type sample in the template;
determining a rate distortion cost of the first candidate filtering coefficient and a rate distortion cost of the second candidate filtering coefficient;
determining a filtering coefficient of a target filtering model from the first candidate filtering coefficient and the second candidate filtering coefficient according to a rate distortion cost of the first candidate filtering coefficient and a rate distortion cost of the second candidate filtering coefficient; and
writing a first index value of the filtering coefficient of the target filtering model into a bitstream.

For example, a group of filtering coefficients with a minimum rate distortion cost in the first candidate filtering coefficient and the second candidate filtering coefficient are used as filtering coefficients of the target filtering model.

In some embodiments, the first type of sample refers to a sample whose sample reference value is greater than or equal to an average value of the sample reference value of the template in which the sample is located. The second type of sample refers to a sample whose sample reference value is less than or equal to the average value of the pixel reference value of the template in which the sample is located.

For example, in some embodiments, the pixel reference value includes at least one of a sample reconstruction value, a sample gradient value of the sample reconstruction value, and sample location information.

In other embodiments, the first model parameter includes a filtering coefficient of a target filtering model. The template includes at least one template sub-area, and the reference template includes at least one matching sub-template. A matching sub-template of the template sub-area is determined according to the first prediction mode.

The process of determining the first model parameter according to the reference template and the template includes:
determining a corresponding third candidate filtering coefficient according to the template sub-area and a corresponding matching sub-template;
determining a rate distortion cost of a third candidate filtering coefficient of the at least one matching sub-template;
determining a filtering coefficient of a target filtering model from the third candidate filtering coefficient according to the rate distortion cost of the third candidate filtering coefficient of the at least one matching sub-template; and
writing a first index value of the filtering coefficient of the target filtering model into a bitstream.

For example, a group of filtering coefficients with a minimum rate distortion cost among the third candidate filtering coefficients of the at least one matching sub-template is used as a filtering coefficient of the target filtering model.

In some embodiments, the encoder may divide the template according to a relative position to the current block, for example, one template sub-area includes an upper adjacent sample and a left adjacent sample of the current block, another template sub-area includes a left adjacent sample and an upper left adjacent sample of the current block, and the like. Any specific division rule may be adopted, provided that any two template sub-regions are not completely overlapped.

In still other embodiments, the first model parameter includes a filtering coefficient of a target filtering model.

The process of determining the first model parameter according to the reference template and the template includes:
determining filtering coefficients of multiple filtering models with different shapes according to the reference template and the template;
determining a rate distortion cost of the filtering coefficients of the multiple filtering models with different shapes;
determining a filtering coefficient of the target filtering model according to the rate distortion costs of the filtering coefficients of the multiple filtering models with different shapes;
parsing a bitstream to obtain a first index value of a filtering coefficient of the target filtering model; and
writing the first index value of the filtering coefficient of the target filtering model into a bitstream.

In some embodiments, the encoder may further write a shape of the multiple filtering models with different shapes and/or a quantity of filtering coefficients of the target filtering models into a bitstream.

In step 905, intra prediction is performed on the current block according to the first prediction mode and the first model parameter, to obtain a predicted value of the current block.

In some embodiments, the encoder or decoder may implement step 905 as follows: performing intra prediction on the current block according to the prediction mode with a minimum prediction cost to obtain a second prediction value; and performing filtering processing on the second prediction value according to the first model parameter to obtain a predicted value of the current block.

In embodiments of this application, a scenario in which filtering processing needs to be used for intra prediction is not limited. For example, filtering processing may be used in any scenario in the following scenarios 1 to 2.

In scenario 1, in some embodiments, when at least one of the following conditions is met, filtering processing is performed on the second prediction value according to the first model parameter to obtain a predicted value of the current block:
the candidate prediction mode includes only a Planar mode and/or a DC mode; and
the one or more candidate prediction modes include only one prediction mode.

In scenario 2, in some embodiments, when the candidate prediction mode does not include only the Planar mode and/or the DC mode, and the candidate prediction mode includes multiple prediction modes, the first prediction mode includes a prediction mode with a minimum prediction cost and a prediction mode with a second minimum prediction cost, or the first prediction mode includes a prediction mode with a minimum prediction cost.

In some embodiments, the second minimum prediction cost indicates a second minimum among a first prediction cost and a second prediction cost. The minimum prediction cost indicates a minimum among the first prediction cost and the second prediction cost. The first prediction cost includes a prediction cost of the candidate prediction mode for the template; and the second prediction cost includes a prediction cost of an adjacent angle mode of prediction modes, for the template, in the candidate prediction mode with a minimum prediction cost and a second minimum prediction cost for the template.

Alternatively, the second minimum prediction cost indicates a second minimum of prediction costs of the candidate prediction mode for the template; the minimum prediction cost indicates a minimum of prediction costs of the candidate prediction mode for the template.

In one scenario of scenario 2, in some embodiments, if the second minimum prediction cost is greater than or equal to a product of the minimum prediction cost and a first value, the first prediction mode includes a prediction mode with the minimum prediction cost, where the first value is greater than 1. Based on this, in some embodiments, the encoder or the decoder may also implement step 905 as follows: performing intra prediction on the current block according to the prediction mode with a minimum prediction cost, to obtain a third predicted value; and performing filtering processing on the third predicted value according to the first model parameter to obtain a predicted value of the current block.

In another scenario of scenario 2, in some embodiments, if the second minimum prediction cost is less than a product of the minimum prediction cost and a first value, the first prediction mode includes a prediction mode with the minimum prediction cost and a prediction mode with the second minimum prediction cost, where the first value is greater than 1. Based on this, for step 905, the performing intra prediction on the current block according to the first prediction mode and the first model parameter to obtain a predicted value of the current block may be implemented by using the following Embodiment 1 or Embodiment 2.

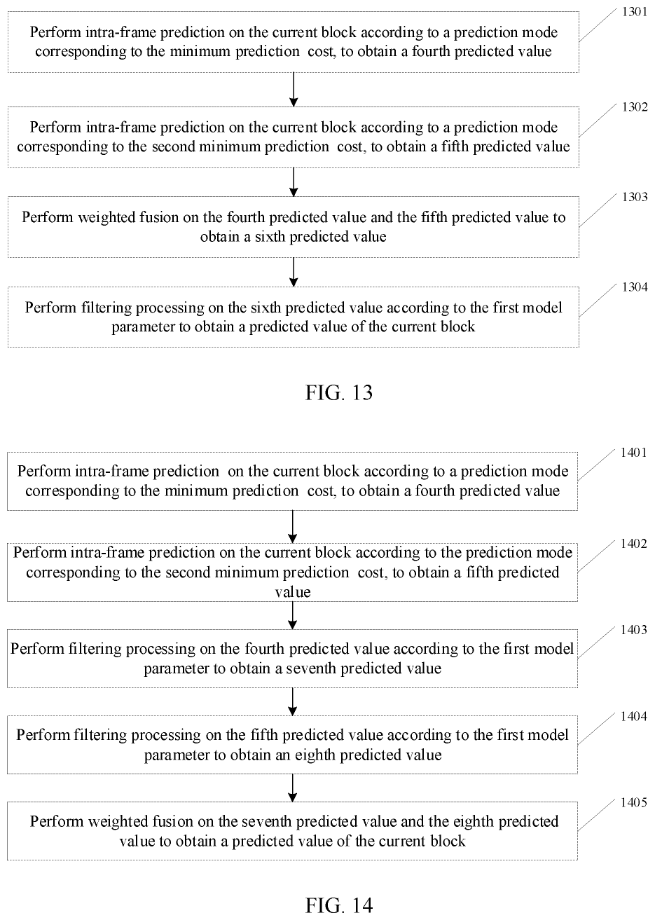

In Embodiment 1, as shown in FIG. 13, the encoder or decoder may implement step 905 by performing the following steps 1301 to 1304.

In step 1301, intra prediction is performed on the current block according to the prediction mode corresponding to the prediction cost, to obtain a fourth predicted value.

In step 1302, intra prediction is performed on the current block according to the prediction mode corresponding to the second minimum prediction cost, to obtain a fifth predicted value.

In step 1303, weighted fusion is performed on the fourth predicted value and the fifth predicted value to obtain a sixth predicted value.

In step 1304, filtering processing is performed on the sixth predicted value according to the first model parameter to obtain a predicted value of the current block.

In Embodiment 2, as shown in FIG. 14, the encoder or decoder may implement step 905 by performing the following steps 1401 to 1404:

In step 1401, intra prediction is performed on the current block according to a prediction mode corresponding to the minimum prediction cost, to obtain a fourth predicted value.

In step 1402, intra prediction is performed on the current block according to the prediction mode corresponding to the second minimum prediction cost, to obtain a fifth predicted value.

In step 1403, filtering processing is performed on the fourth predicted value according to the first model parameter to obtain a seventh predicted value.

In step 1404, filtering processing is performed on the fifth predicted value according to the first model parameter to obtain an eighth predicted value.

In step 1405, weighted fusion is performed on the seventh predicted value and the eighth predicted value to obtain a predicted value of the current block.

Alternatively, in other embodiments, the encoder or decoder may perform weighted fusion on the fourth predicted value and the eighth predicted value to obtain a predicted value of the current block. In this case, the encoder or decoder does not need to perform step 1403.

Alternatively, in still another embodiment, the encoder may perform weighted fusion on the seventh predicted value and the fifth predicted value to obtain a predicted value of the current block. In this case, the encoder or decoder does not need to perform step 1404.

In embodiments of this application, the weighting coefficient used for weighted fusion may be a preset value, or may be a value related to a prediction cost. For example, the weighting coefficients of the two predicted values may be represented by the following formula:

$$weight 1 = uiSecondaryCost / ( uiBestCost + uiSecondaryCost )$$

$$weight 2 = 1 - weight 1$$

In which, weight 1 represents a weighting coefficient of a predicted value obtained based on a prediction mode with a minimum prediction cost (uiBestCost), for example, the weighting coefficient is a weight of a fourth predicted value or a seventh predicted value, and weight 2 represents a weighting coefficient of a predicted value obtained based on a prediction mode with a second minimum prediction cost (uiSecondaryCost), for example, the weighting coefficient is a weighting coefficient of a fifth predicted value or of an eighth predicted value.

In this embodiment of this application, a condition in which the encoder or the decoder uses the first model parameter may be limited, or may be not limited. When the condition is limited, the following embodiment describes three cases, for example.

In some embodiments, when a first matching error between the reference template and the template region is greater than or equal to a first threshold, the encoder or decoder performs step 905: performing intra prediction on the current block according to the first prediction mode and the first model parameter.

In other embodiments, in a case that a second matching error between the reference template and the template region subjected to filtering by using the first model parameter is greater than or equal to a second threshold, intra prediction is performed on the current block according to the first prediction mode and the first model parameter.

In still other embodiments, the encoder may control, by syntax elements, whether the decoder performs the filtering processing for the current block. The encoder may write first syntax identifier information and second syntax identifier information into a bitstream.

When the first syntax identifier information received by the decoder is equal to a third value and the second syntax identifier information received by the decoder is equal to a fourth value, intra prediction is performed on the current block according to the first prediction mode and the first model parameter.

The third value represents that intra prediction is performed on the current block by using an intra-frame mode derivation method based on a template, and the fourth value represents that intra prediction is performed on the current block by using the first model parameter.

It may be understood that in this embodiment, the encoder transmits a Flag to indicate whether to apply the filtering processing technology based on the first model parameter. timdFlag (first syntax identifier information) is used to indicate whether to apply the template-based intra-frame mode derivation technology on the current coding block, and filterFlag (second syntax identifier information) is used to indicate whether to apply the filtering model on the current coding block. When timdFlag is 1, the encoder determines whether to determine the prediction value of the current block by step 905 by comparing distortion between the prediction block before and after the filtering and the original block, such as SAD, MSE, SATD, or SSE. If the distortion after filtering is less than the distortion before filtering, filterFlag is 1, the filtered prediction block is used as the prediction block of the current coding block; otherwise, filterFlag is 0, the prediction block before filtering is used as the prediction block of the current coding block, and the encoder transmits filterFlag to the decoder.

Certainly, the encoder or the decoder may use the prediction value output in step 905 as a final predicted value of the current block, or may perform filtering processing on the predicted value output in step 905 to obtain the final predicted value of the current block. For example, in some embodiments, the method further includes: performing filtering processing on the predicted value of the current block according to the first model parameter to obtain the predicted value of the current block.

In some embodiments, the first model parameter includes a filtering coefficient of a target filtering model.

In some embodiments, the filtering processing includes: determining a product of a filter coefficient of the target filtering model and a predicted value of a corresponding location; and setting a first output value of the target filtering model to be equal to a sum of n products, where N represents a quantity of filtering coefficients of the target filtering model, and n is a positive integer.

It may be understood that the first output value of the target filtering model is a predicted value after filtering at a corresponding location in the current block.

For example, in some embodiments, the output value of the filtering processing is equal to a first output value of the target filtering model, or the output value of the filtering processing is equal to a sum of the first output value of the target filtering model and a first offset value.

In some embodiments, the first offset value is equal to a preset second value.

In other embodiments, the encoder or decoder may also determine the first offset value based on sample reconstruction values corresponding to at least one filter coefficient different from a location of the first output value of the target filtering model.

In some embodiments, if a part of input position of the target filtering model exceeds the current block, the predicted value of the part of input position is equal to the corresponding sample reconstruction value.

For example, in some embodiments, a predicted value of the part of input position is equal to a corresponding sample reconstruction value, if at least one of the following conditions is met:
a sample position corresponding to the part of input position is already reconstructed; and

The part of input position does not exceed a boundary of a current image;

The part of input position does not exceed a Tile boundary.

In other embodiments, the part of input position is not used as the output position of the target filtering model, in a case that the part of input position of the target filtering model exceeds the current block.

In some embodiments, the encoding method further includes: determining a prediction difference of a current block according to an original value of the current block and a predicted value of the current block; and generating a bitstream according to the prediction difference of the current block.

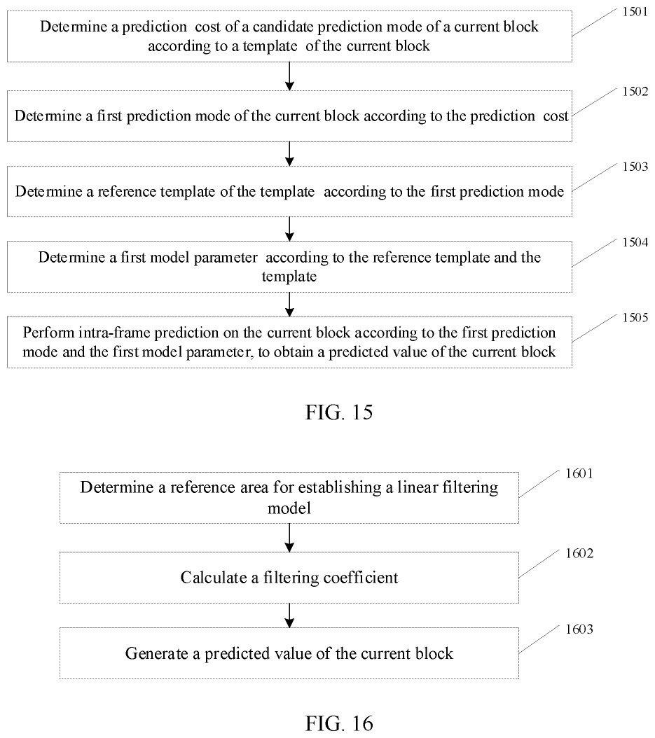

An embodiment of this application provides a decoding method. The method may be applied to the decoder 200 shown in FIG. 2. FIG. 15 is a schematic flowchart of implementation of the decoding method according to an embodiment of this application. As shown in FIG. 15, the method includes the following steps 1501 to 1505.

In step 1501, a prediction cost of a candidate prediction mode of a current block is determined according to a template of the current block.

In step 1502, a first prediction mode of the current block is determined according to the prediction cost.

In step 1503, a reference template of the template is determined according to the first prediction mode.

In step 1504, a first model parameter is determined according to the reference template and the template.

In step 1505, intra prediction is performed on the current block according to the first prediction mode and the first model parameter, to obtain a predicted value of the current block.

In some embodiments, the decoding method further includes: determining a template of the current block according to adjacent samples of the current block.

Exemplarily, in some embodiments, adjacent samples of the current block include at least one of the following:
an upper adjacent sample of the current block;
an upper-left adjacent sample of the current block;
a left adjacent sample of the current block;
a left adjacent sample of the current block;
a lower-left adjacent sample of the current block.

In some embodiments, the template of the current block includes available adjacent samples of the current block.

In some embodiments, the decoding further includes determining a size of the template according to a size of the current block.

In some embodiments, the candidate prediction mode includes one or more prediction modes, and the prediction cost includes a prediction distortion value corresponding to the one or more prediction modes.

In some embodiments, the decoding method further includes: determining the one or more prediction modes; performing intra prediction on the template according to the prediction mode to obtain a first predicted value; and determining a prediction distortion value of the prediction mode for the template according to the first predicted value corresponding to the prediction mode and a first reconstruction value of the template.

In some embodiments, the process of determining the one or more prediction modes includes: determining the one or more prediction modes according to a second prediction mode used to perform intra prediction on an adjacent block of the current block.

In some embodiments, the adjacent block includes at least one of the following:
a left adjacent block of the current block;
a lower-left adjacent block of the current block;
an upper-right adjacent block of the current block;
an upper adjacent block of the current block; or
an upper-left adjacent block of the current block.

In some embodiments, in a case that the second prediction mode includes no angular prediction mode, the one or more prediction modes include a Planar mode and/or a DC mode.

In some embodiments, in a case that the second prediction mode includes an angular prediction mode, the one or more prediction modes include a prediction mode in an MPM list of the current block constructed according to information of the adjacent block. The prediction mode may include a wide angle prediction mode.

In some embodiments, in a case that the MPM list includes no third prediction mode, the third prediction mode is added to the MPM list.

In some embodiments, the third prediction mode includes a DC mode, an HOR mode, and/or a VER mode.

In some embodiments, the first prediction mode is one or more prediction modes selected from the candidate prediction modes.

In some embodiments, the first prediction mode includes a prediction mode with a minimum prediction cost in the candidate prediction mode.

In some embodiments, the process of determining a reference template of the template according to the first prediction mode includes: determining a reference template of the template according to the prediction mode with a minimum prediction cost.

In some embodiments, the process of determining a first model parameter according to the reference template and the template includes: determining the first model parameter according to a sample reference value in the reference template and a sample reference value in the template.

In some embodiments, the process of determining the first model parameter according to the sample reference value of the reference template and the sample reference value of the template includes: determining an autocorrelation parameter according to the sample reference value in the reference template; and determining a cross-correlation parameter according to the sample reference value in the template and the sample reference value in the reference template; and determining the first model parameter according to the autocorrelation parameter and the cross-correlation parameter.

In some embodiments, when a part of input position of a target filtering model corresponding to the first model parameter exceeds the reference template or template, the reference template or template is filled with a sample reference value corresponding to the part of input position.

In some embodiments, the reference template or template is filled with the sample reference value corresponding to the part of input location, if at least one of the following conditions is met:
a sample position corresponding to the part of input position is already reconstructed;
the parti of input position does not exceed a boundary of a current image; or
the part of input position does not exceed ae Tile boundary.

In some embodiments, when a part of input location of the target filtering model corresponding to the first model parameter exceeds the reference template, the part of input location does not participate in determining the first model parameter.

In some embodiments, the sample reference value includes at least one of: a sample reconstruction value, a sample gradient value of the sample reconstruction value, and sample location information.

In some embodiments, the process of performing intra prediction on the current block according to the first prediction mode and the first model parameter to obtain a predicted value of the current block includes: performing intra prediction on the current block according to the prediction mode with a minimum prediction cost, to obtain a second predicted value; and performing filtering processing on the second predicted value according to the first model parameter to obtain a predicted value of the current block.

In some embodiments, in a case that at least one of the following conditions is met, filtering processing is performed on the second predicted value according to the first model parameter to obtain a predicted value of the current block:

the candidate prediction mode includes only a Planar mode and/or a DC mode; and

the one or more candidate prediction modes include only one prediction mode.

In some embodiments, when the candidate prediction mode does not include only a Planar mode and/or a DC mode, and the candidate prediction mode includes multiple prediction modes, the first prediction mode includes a prediction mode with a minimum prediction cost and a prediction mode with a second minimum prediction cost, or the first prediction mode includes a prediction mode with a minimum prediction cost.

In some embodiments, the second minimum prediction cost indicates a second minimum among a first prediction cost and a second prediction cost; and the minimum prediction cost indicates a minimum among the first prediction cost and the second prediction cost.

The first prediction cost includes a prediction cost of the candidate prediction mode for the template; and the second prediction cost includes a prediction cost of an adjacent angle mode of prediction modes, for the template, in the candidate prediction mode with a minimum prediction cost and a second minimum prediction cost for the template.

In some embodiments, the second minimum prediction cost indicates a second minimum of prediction costs of the candidate prediction mode for the template; and the minimum prediction cost indicates a minimum of prediction costs of the candidate prediction mode for the template.

In some embodiments, if the second minimum prediction cost is greater than or equal to a product of the minimum prediction cost and a first value, the first prediction mode includes a prediction mode with the minimum prediction cost. The first value is greater than 1.

In some embodiments, the process of performing intra prediction on the current block according to the first prediction mode and the first model parameter to obtain a predicted value of the current block includes: performing intra prediction on the current block according to the prediction mode with a minimum prediction cost, to obtain a third predicted value; and performing filtering processing on the third predicted value according to the first model parameter to obtain a predicted value of the current block.

In some embodiments, if the second minimum prediction cost is less than a product of the minimum prediction cost and a first value, the first prediction mode includes a prediction mode with the minimum prediction cost and a prediction mode with the second minimum prediction cost. The first value is greater than 1.

In some embodiments, the process of performing intra prediction on the current block according to the first prediction mode and the first model parameter to obtain a predicted value of the current block includes: performing intra prediction on the current block according to a prediction mode corresponding to a minimum prediction cost, to obtain a fourth predicted value; performing intra prediction on the current block according to the prediction mode corresponding to the second minimum prediction cost, to obtain a fifth predicted value; and performing weighted fusion on the fourth predicted value and the fifth predicted value to obtain a sixth prediction value; and

performing filtering processing on the sixth predicted value according to the first model parameter to obtain a predicted value of the current block.

In some embodiments, the process of performing intra prediction on the current block according to the first prediction mode and the first model parameter to obtain a predicted value of the current block includes: performing intra prediction on the current block according to a prediction mode corresponding to a minimum prediction cost, to obtain a fourth predicted value; performing intra prediction on the current block according to a prediction mode corresponding to the second minimum prediction cost, to obtain a fifth predicted value; performing filtering processing on the fourth predicted value according to the first model parameter to obtain a seventh predicted value, and/or performing filtering processing on the fifth predicted value according to the first model parameter to obtain an eighth predicted value; performing weighted fusion on the fourth predicted value and the eighth predicted value, or performing weighted fusion on the seventh predicted value and the eighth predicted value, or performing weighted fusion on the seventh predicted value and the fifth predicted value, to obtain the predicted value of the current block.

In some embodiments, the decoding method further includes: performing filtering processing on the predicted value of the current block according to the first model parameter to obtain the predicted value of the current block.

In some embodiments, the decoding method further includes: decoding a bitstream to determine a prediction residual of the current block; and determining a reconstruction value of the current block according to the predicted value of the current block and the prediction residual of the current block.

In some embodiments, the first model parameter includes a filtering coefficient of a target filtering model.

In some embodiments, the filtering processing includes: determining a product of a filter coefficient of the target filtering model and a predicted value of a corresponding location; and setting a first output value of the target filtering model to be equal to a sum of n products, where n represents a quantity of filtering coefficients of the target filtering model, and n is a positive integer.

In some embodiments, if a part of input position of the target filtering model exceeds the current block, a predicted value of the part of input position is equal to a corresponding sample reconstruction value.

In some embodiments, the predicted value of the part of input position is equal to the corresponding sample reconstruction value, if at least one of the following conditions is met:
a sample position corresponding to the part of input position is already reconstructed;
the part of input position does not exceed a boundary of a current image; or
the part of input position does not exceed a Tile boundary.

In some embodiments, the part of input position is not used as an output position of the target filtering model, if the part of input position of the target filtering model exceeds the current block.

In some embodiments, the output value of the filtering processing is equal to a first output value of the target filtering model, or the output value of the filtering processing is equal to a sum of the first output value of the target filtering model and a first offset value.

In some embodiments, the first offset value is equal to a preset second value.

In some embodiments, the decoding method further includes: determining the first offset value according to a sample reconstruction value corresponding to at least one filter coefficient that is different from a location of the first output value of the target filtering model.

In some embodiments, the first model parameter includes a filtering coefficient of a target filtering model. The process of determining the first model parameter according to the reference template and the template includes: determining a first candidate filtering coefficient of the target filtering model according to a sample reference value of a first-type sample in the reference template and a sample reference value of a first-type sample in the template; determining a second candidate filtering coefficient of the target filtering model according to a sample reference value of a second-type sample in the reference template and a sample reference value of a second-type sample in the template; parsing a bitstream to obtain a first index value of a filtering coefficient of the target filtering model; and determining a filtering coefficient of a target filtering model from the first candidate filtering coefficient and the second candidate filtering coefficient according to the first index value.

In some embodiments, the first type of sample is a sample whose sample reference value is greater than or equal to an average value of the sample reference value of a template in which the sample is located. The second type of sample is a sample whose sample reference value is less than or equal to the average value of the sample reference value of a template in which the sample is located.

In some embodiments, the first model parameter includes a filtering coefficient of a target filtering model. The template includes at least one template sub-area, and the reference template includes at least one matching sub-template. A matching sub-template of the template sub-area is determined according to the first prediction mode. The process of determining the first model parameter according to the reference template and the template includes: determining a corresponding third candidate filtering coefficient according to the template sub-area and a corresponding matching sub-template; parsing a bitstream to obtain a first index value of a filtering coefficient of the target filtering model; and determining, according to the first index value, the filtering coefficient of the target filtering model from third candidate filtering coefficients corresponding to the at least one template sub-region.

In some embodiments, the first model parameter includes a filtering coefficient of a target filtering model. The process of determining the first model parameter according to the reference template and the template includes: determining filtering coefficients of multiple filtering models with different shapes according to the reference template and the template; parsing a bitstream to obtain a first index value of a filtering coefficient of the target filtering model; and determining the filtering coefficient of the target filtering model from the filtering coefficients of the multiple filtering models with different shapes according to the first index value.

In some embodiments, the decoding method further includes: parsing a bitstream to determine a shape of the target filtering model and/or a quantity of filtering coefficients of the target filtering model.

In some embodiments, the decoding method further includes: parsing a bitstream to determine a shape of the multiple filtering models with different shapes and/or a quantity of filtering coefficients of the target filtering models.

In some embodiments, when a first matching error between the reference template and the template is greater than or equal to a first threshold, intra prediction is performed on the current block according to the first prediction mode and the first model parameter.

In some embodiments, in a case that a second matching error between the reference template and the template subjected to filtering by using the first model parameter is greater than or equal to a second threshold, intra prediction is performed on the current block according to the first prediction mode and the first model parameter.

In some embodiments, the decoding method further includes: parsing a bitstream to obtain first syntax identifier information and second syntax identifier information; and

when the first syntax identifier information is equal to a third value and the second syntax identifier information is equal to a fourth value, performing intra prediction on the current block according to the first prediction mode and the first model parameter.

The third value represents that intra prediction is performed on the current block by using an intra-frame mode derivation method based on a template, and the fourth value represents that intra prediction is performed on the current block by using the first model parameter.

It should be noted that in embodiments of this application, both the encoder and the decoder need to determine the predicted value of the current block by performing a same operation. For an operation of selecting a group of filtering coefficients from the multiple groups of candidate filtering coefficients as a first model parameter, the decoder also needs to determine the multiple groups of candidate filtering coefficients by performing an operation similar to that performed by the encoder. A difference is that the decoder does not need to select a group of filtering coefficients as the first model parameter based on a rate distortion cost, but instead obtains an index value of the first model parameter from the bitstream. Based on this, the first model parameter is determined from the multiple groups of candidate filtering coefficients.

Therefore, the decoding method embodiments are similar to the encoding method embodiments, and have beneficial effects similar to those of the encoding method embodiments. For technical details not disclosed in the decoding method embodiments of this application, one may refer to the description in the encoding method embodiments of this application.

The following describes an exemplary application of embodiments of this application in an actual application scenario.

Main technical solution:
In the prediction process of the TIMD, a linear model is proposed for a template of a current block and a template (i.e., the reference template) used for an optimal mode of the TIMD, so as to fully utilize information of all adjacent reconstructed sampling points and filter the prediction block of the current block by using the linear model.

The following describes the prediction process of the proposed method in detail:

Input of TIMD: location of the current block (xTbCmp, yTbCmp), width uiWidth of the current block, and height uiHeight of the current block.

Output of TIMD: The predicted value of the current block is predSamples[x][y], where x=0 . . . nTbW−1, y=0 . . . nTbH−1.

As shown in FIG. 4, a specific prediction process of the TIMID technology includes the following steps 401 to 404:

In step 401, a template type and a size of a template of a current block are determined.

In step 402, a reference area sample is obtained.

In step 403, a prediction mode of the TIMID is obtained.

In step 404, a final predicted value of the current block is generated.

After the foregoing process, a predicted value of the current block may be obtained.

The following describes in detail:

In step 401, a current template type and size are determined.

The templates available in the TIMD technology include an upper adjacent reconstructed sample area and a left adjacent reconstructed sample area. The template type (eTempType) is determined according to a location of the current block. For example:

If both the left and upper adjacent reconstructed samples are unavailable, eTempType is NO_NEIGHBOR, and there is no template.

If both the left and upper adjacent reconstructed samples are available, eTempType is LEFT_ABOVE_NEIGHBOR, and the template is 501 and 502 as shown in FIG. 5.

If only the left adjacent reconstructed samples are available, eTempType is LEFT_NEIGHBOR, and the template is 601 shown in FIG. 6.

If only the upper adjacent reconstructed samples are available, eTempType is ABOVE_NEIGHBOR, and the template is 701 shown in FIG. 7.

The template size of the template used by the TIMD technology is related to the current block size. For example:

If the height (uiHeight) of the current block is greater than or equal to 8, the template height (iTempHeight) is 4; otherwise, the template height is 2.

If the width (uiWidth) of the current block is greater than or equal to 8, the template width (iTempWidth) is 4; otherwise, the template width is 2.

In step 402, a reference area sample is obtained.

As shown in FIG. 8, the reference areas available in the TIMD technology include adjacent reconstructed sample areas on the left and upper sides of the template. It is assumed that a length of a left adjacent reconstructed sample area is m_leftRefLength, and a length of an upper adjacent reconstructed sample area is m_topRefLength.

$$m\_leftRefLength = ( uiHeight + iTempHeight ) ≪ 3$$

$$m\_topRefLength = ( uiWidth + iTempWidth ) ≪ 3$$

In step 403, a prediction mode of the TIMD is obtained.

To obtain the prediction mode of the TIMID, first, a prediction mode set (an example of the candidate prediction mode of the current block mentioned above) needs to be obtained. Then, the prediction mode set is traversed to calculate the predicted value for the template. The prediction mode of the TIMD is selected for the current block by calculating the prediction cost.

In the TIMD technology, the encoder or decoder selects a prediction mode set according to a prediction mode of an adjacent block (left, lower left, upper right, upper, upper left) of the current block.

If an angle prediction mode does not exist for an adjacent block, the prediction mode set includes a Planar mode and/or a DC mode.

If an angle prediction mode exists for an adjacent block, the prediction mode set includes an MPM list and a wide angle prediction mode. If there is no DC/HOR/VER mode in the MPM list, DC/HOR/VER mode is added at the end of the MPM list.

At step 404, a final predicted value of the current block is generated.

(1) If the prediction mode set includes only the Planar mode and/or the DC mode, after the prediction mode set is traversed in the template, a mode with a minimum prediction cost (iBestMode) is selected as a first prediction mode, and weighted fusion is not performed. That is, predSamples[x][y] is directly obtained by using a corresponding method of the first prediction mode, where x=0, . . . , nTbW−1, y=0, . . . , nTbH−1.

(2) Otherwise (that is, in a case that the prediction mode set does not include only the Planar mode and/or the DC mode), the mode information obtained from the bitstream is determined. If TIMD-FLM is true, a process of constructing predSamples[x][y] by using the linear filtering model is performed, as described in S4.2 below.

(3) Otherwise (that is, in a case that the prediction mode set does not include only the Planar mode and/or the DC mode), if there is only one candidate prediction mode of the TIMD, weighted fusion is not performed, and prediction is performed on the current block by using the iBestMode to obtain the final predicted value. That is, predSamples[x][y] is directly obtained by using a corresponding method of the prediction mode, where x=0, . . . , nTbW−1, y=0, . . . , nTbH−1.

If there is more than one candidate prediction mode of the TIMD, after the prediction mode set is traversed in the template, a mode with a minimum prediction cost (iBestMode) and a mode with a second minimum prediction cost (iSecondaryMode) are obtained. Then, adjacent angle modes (+1 and −1) of the iBestMode and the iSecondaryMode are checked, calculated and updated as prediction modes of the TIMD, and prediction costs of the four adjacent angle modes for the template are determined. Based on this, a mode with a minimum prediction cost (still indicated as iBestMode, that is, updated iBestMode) and a mode with a second minimum prediction cost (still indicated as iSecondaryMode, that is, updated iSecondaryMode) are determined from the iBestMode, the adjacent angle modes (+1 and −1) of the iBestMode, the iSecondaryMode, and the adjacent angle modes (+1 and −1) of the iSecondaryMode. It is assumed that prediction costs of iBestMode and iSecondaryMode are respectively uiBestCost and uiSecondaryCost. If the TID fusion condition is met, a TID fusion weight is calculated. It is determined whether to apply weighted fusion according to the size of uiBestCost and uiSecondaryCost.

If uiSecondaryCost>=2*uiBestCost, weighted fusion is not applied, and the current block is predicted by using iBestMode, to obtain a final predicted value. That is, predSamples[x][y] is directly obtained by using a corresponding method of the prediction mode, where x=0, . . . , nTbW−1, y=0, . . . , nTbH−1.

If uiSecondaryCost<2*uiBestCost, weighted fusion is applied. It is assumed that a weight of iBestMode is weight1, and a weight of iSecondaryMode is weight2. Details are as follows:

$$weight 1 = uiSecondaryCost / ( uiBestCost + uiSecondaryCost )$$

$$weight 2 = 1 - weight 1$$

Two predicted values (pelPred[x][y] and pelPredFusion[x][y], where x=0 . . . nTbW−1, y=0 . . . nTbH−1) of the current block are obtained by using iBestMode and iSecondaryMode. Then, weighted fusion is applied to obtain a final predicted value predSamples[x][y]. Details are as follows:

$$predSamples [ x ] [ y ] = pelPred [ x ] [ y ] * weight 1 + pelPredFusion [ x ] [ y ] * weight 2$$

S4.2, Process of obtaining a predicted value based on TIMD-FLM mode

FIG. 5, Process of obtaining a predicted value based on TIMD-FLM mode

FIG. 16 shows a procedure of obtaining a predicted value in a TIMD-FLM mode, including the following steps 1601 to 1603.

In step 1601, a reference area for establishing a linear filtering model is determined.

In step 1602, a filtering coefficient is calculated.

In step 1603, a predicted value of the current block is generated.

A linear filtering model is established by using the best matching template (i.e., the reference template) obtained previously by using the SATD and the current block template (i.e., the template). The method mainly includes the following two processes: determining a reconstruction area used to calculate a filtering coefficient of the filtering model, and calculating a filtering coefficient of the filtering model.

A quantity of taps of the filter (that is, a filter model) is defined as nTap. nTap may be a constant, or may be a variable, for example, a quantity of taps of the filter may be dynamically adjusted according to a block size. In this solution, multiple shapes of filters may be selected. In an embodiment, a fixed-shape filter shown in FIG. 12 is selected, where the quantity of filter taps nTap is 5.

In step 1601, a reference area used to establish a linear filtering model is determined.

Available reconstructed pixels are determined according to the template type eTempType. For example, when the template type eTempType is LEFT_ABOVE_NEIGHBOR, 501 and 502 shown in FIG. 5 indicate that left and upper adjacent reconstructed samples are available, a quantity of left available reconstructed samples is templateW_size*nTbH, and a quantity of upper available reconstructed samples is templateH_size*nTbW.

Boundary samples are filled. Considering that the filter may use reconstruction samples other than the template and the reference template, the boundary samples need to be filled. According to different filter shapes, different areas of the boundary need to be filled.

There are multiple different methods for filling:

One filling manner is to determine whether the current block is available. If so, the reconstructed pixels are directly used to fill the current block. If not, the reconstructed pixels in the adjacent template are copied to fill the current block.

Another filling manner is to directly copy the reconstructed pixels of adjacent templates to fill the current block.

Alternatively, filling may not be performed, and a corresponding data of a boundary position does not participate in calculation.

The availability determining includes but is not limited to one or more of the following conditions:
a location sampling point has been reconstructed;
a position does not exceed an image boundary;
a position does not exceed the Tile boundary.

After the available reconstructed pixels are determined, a reconstruction area for calculating the filtering coefficient of the filtering model is determined according to the available reconstructed pixels. The area is referred to as R, and R generally includes all the available reconstructed pixels in the template. For example, when eTempType is LEFT_ABOVENEIGHBOR, R includes all the available reconstructed pixels on the left side and on the upper side.

S4.202. Calculate a filtering coefficient of the filtering model.

After the reconstruction area R for calculating the filtering coefficients of the filtering model is determined, a set of filtering coefficients of the filtering model is derived by minimizing MSE between the reconstruction pixels in the area R and the reconstruction pixels of the current block template.

In step 1602, a filtering coefficient is calculated.

If there is only one candidate mode of the TID, weighted fusion is not performed, and prediction is performed on the current block by using the iBestMode to obtain a predicted value. Then, the non-merge TIMD prediction value is filtered according to the filter shape and the filter coefficient of the filter model, that is,

For a current to-be-encoded block, a filtering coefficient of a group of filtering models can be obtained by establishing a linear filtering model, and the filtering coefficient of the group of filtering models is c₀, c₁, c₂ . . . c_{nTap-1}. Then, the non-merge TIMD prediction value is filtered according to the filter shape and the filter coefficient of the filter model, that is, a weighted sum of the filter coefficient of the filter model and the prediction pixel of the corresponding position is calculated to obtain the final prediction value of the current block.

A specific prediction value calculation process is described as follows.

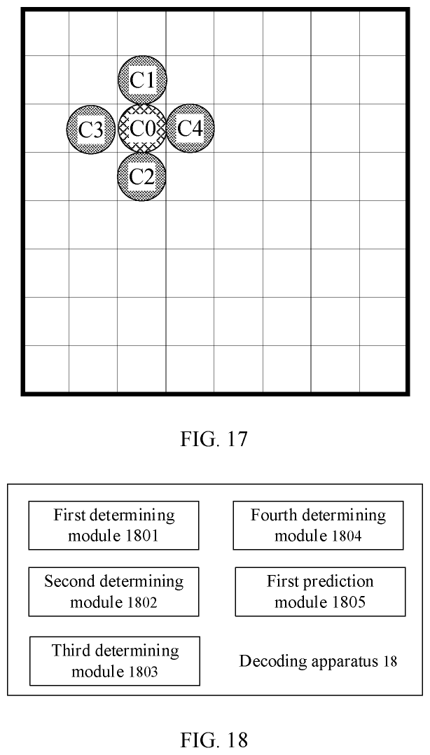

It is assumed that a quantity nTap of taps of the filter is 5, and a shape of the filter is shown in FIG. 17, c₀ to c₄ respectively represent tapping coefficients of the filter. In which, a point corresponding to the tapping coefficient C₀ represents a final prediction pixel

$${Y}_{final}^{pred} [ i ] ⌈ j ]$$

of a current block, that is, a prediction pixel Y^{pred} [i][j] at a corresponding location in a best matching block. Points corresponding to remaining tapping coefficients represents prediction pixels in the current block adjacent to a current spatial location.

A specific prediction value calculation process is as follows:

For each current to-be-predicted sample (i, j), a sample position of the filter in the current block is defined as (k, l), a sample corresponding to the prediction block during filtering is defined as

$${Y}_{final}^{pred} [ i + k ] [ j + l ] ,$$

and a filter coefficient of each filter model at a position (k, l) of the filter in the current block is defined as c_{k,l}:

$${c}_{k , l} = {c}_{n}$$

Where n=0, . . . , nTap−1, k and l are between −1 and 1.
For i=0, . . . , nTbW−1, j=0, . . . , nTbH−1:

$${Y}_{final}^{pred} [ i ] [ j ] = {\sum }_{k} {\sum }_{l} {Y}^{pred} [ i + k ] [ j + l ] \times {C}_{, k , l}$$

The final prediction value is:

$$predSamples [ i ] [ j ] = Clip 3 ( 0 , ( 1 ≪ BitDepth ) - 1 , {Y}_{final}^{pred} [ i ] [ j ] )$$

$$Herein ,$$

$$Clip 3 ( x , y , z ) = \{ \begin{matrix}x ; z < x \\ y ; z > y \\ z ; otherwise\end{matrix}$$

The foregoing method provided in this embodiment of this application can effectively correct a prediction value of an intra-frame mode derivation technology based on a template, so as to improve prediction accuracy. In this main technical solution, a linear filtering model is established between the best matching template (that is, the reference template) obtained by searching and the current block template (that is, the template), and a filtering coefficient of the filtering model is obtained by minimizing the MSE between the prediction template (that is, the prediction template=the filtering coefficient of the filtering model×the matching template) and the current block template. The filtering coefficient of the filtering model fully reflects a correlation between the matching template (that is, the reference template) and the current block template (that is, the template), and applies this correlation to the current block, performs filtering correction on a predicted value of the current block, and uses a filtered prediction pixel as a final prediction pixel, thereby improving prediction accuracy to a certain extent.

In embodiments of this application, a template-based intra-frame mode derivation technology TIMD-FLM based on a linear filtering model is proposed. A linear filtering model is established by using a matching template (that is, the reference template) and a current block template (that is, the template), a correlation between the matching template and the current block template is fully used, and a pixel of a current prediction block is corrected by filtering, and a filtered predicted value is used as a final predicted value, thereby improving prediction accuracy to a certain extent.

The main solution contains the following contents:

A linear filtering model is established between the best matching template obtained by searching and the current block template, a filtering coefficient of the filtering model is obtained by minimizing MSE between the prediction template (prediction template=filtering coefficient of the filtering model×matching template) and the current block template, filtering correction is performed on the current prediction block, and the filtered predicted pixel is used as the final predicted pixel.

### Extension Solution 1:

Input information used to calculate the filtering coefficient of the filtering model in the main solution is extended.

In the main solution, the input information used to calculate the filtering coefficient of the filtering model is an available reconstructed pixel of the matching template.

### Extension Solution 1.1:

A gradient of each pixel in the matching template may be calculated, including but not limited to a horizontal gradient, a vertical gradient, and the like, and the calculated gradient is used as input information for calculating a filtering coefficient of the filtering model.

### Extension Solution 1.2:

Position information of each pixel may be used as input information for calculating a filtering coefficient of a filter, and the position information may be absolute position information of each pixel in an entire picture, or may be relative position information of each pixel relative to a reference point.

### Extension Solution 2:

Another implementation manner for calculating the filtering coefficient of the filtering model in the main solution is as follows:

In a main solution, a finally calculated filtering coefficient of the filtering model is a tap coefficient corresponding to the filter, that is, a quantity of filtering coefficients of the filtering model is equal to a quantity of filter taps nTap. In addition, several offset items bias (that is, the first offset value) may be added to the filter, for example:

In a main solution, when nTap=5, a filtering coefficient of the filtering model is a tap coefficient c₀ to c₄ corresponding to the filter, and a predicted value calculated for a position (i, j) is:

$${Y}^{pred} [ i ] [ j ] = {\sum }_{n = 0}^{4} ref [ k ] [ l ] \times {C}_{n}$$

In this case, an offset item may be added, as shown in the following formula:

$${Y}^{pred} [ i ] [ j ] = {\sum }_{n = 0}^{4} ref [ k ] [ l ] \times {C}_{n} + {C}_{5} \times Constant$$

In which, cₙ=c_{i,j,k,l}; Constant may be a fixed constant, for example, Constant=1<<(BitDepth−1), or may be a value related to a reconstructed pixel value corresponding to a tap in a filter at a position except an (i, j) position, for example, Constant=f (ref[k][1]). Constant=f (ref [i][j]) or Constant=f (ref [k][1]) may be a linear mapping relationship, or may be a non-linear mapping relationship. One or more offset items may be added.

### Extension Solution 3:

The quantity of filtering models in the main scheme is extended.

In the main solution, only one linear filtering model is established, and multiple linear filtering models may be established.

The input information for calculating the filtering coefficient of the filtering model is classified, and the filtering model is established for input information of each category.

For example, when a model is established by using reconstruction information, an implementable solution is to classify by using an average value of reconstruction information, a model is established by using reconstruction information greater than the average value, and a model is established by using reconstruction information less than the average value.

Another implementable solution is to classify by using locations of reconstruction information. For example, a model may be established by using available reconstruction information on the left side and the upper side, and a second model may be established by using available reconstruction information on the left side, and the upper left side. The encoding end determines which model is to be used. An implementable decision manner is that the encoding end determines which model is to be used in a manner of rate distortion optimization, and transmits a corresponding Flag to the decoding end.

Another implementable solution is to classify based on filter shapes. Multiple filters with different shapes may be used, and a filter model is established for each shape of filter. The encoding end determines which shape of filter is to be used. In an implementable decision manner, the encoding end determines which filter is to be used in a manner of rate distortion optimization, and transmits a corresponding Flag to the decoding end.

### Extension Solution 4:

Extending the filter model type in the main solution:

### Extension Solution 5:

Extending the part of calculating the prediction value in the main solution: determining, by using some conditions, whether the current block uses the filtered predicted value as the final predicted value. For example, there are the following manners:

determining whether to filter the matching template by comparing a threshold T_Distortion1 and a distortion between the matching template and the current coding template, such as SAD, MSE, SATD or SSE.

On the basis of (1) satisfying the use of the filtering model, whether to perform filtering on the current block is determined by comparing a threshold T_Distortion2 and a distortion between the filtered matching template and the template of the current block, such as SAD, MSE, SATD or SSE, and a threshold T_Distortion2.

The encoding end transmits Flag to indicate whether to apply the filtering model. timdFlag is used to indicate whether the template-based intra-frame mode derivation technology is applied to the current block, and filterFlag is used to indicate whether the filtering model is applied to the current block. When timdFlag is 1, the encoding end determines whether to filter the prediction block by comparing the distortion between the prediction block and the original block before and after filtering, such as SAD, MSE, SATD, or SSE. If the distortion after filtering is less than the distortion before filtering, filterFlag is 1, the filtered prediction block is used as the prediction block of the current block. Otherwise, filterFlag is 0, the prediction block before filtering is used as the prediction block of the current block, and the encoding end transmits the filterFlag to the decoding end.

### Extension Solution 6:

For a process of obtaining a prediction value of a coding block, only prediction in the TIMD-FLM mode may be implemented, or only weighted prediction in the TIMD mode may be implemented, or the prediction in the TIMD-FLM mode may be first implemented and then weighted prediction in the TIMD mode may be implemented. In this case, the weighted prediction value of the TIMD may be calculated by using the foregoing calculation method, or may be calculated by using a prediction template after implementation of the TIMD-FLM. The prediction value may be corrected based on the TIMD-FLM mode, by using only BestMode, or both BestMode and SecondBestMode.

### Extension Solution 7:

The method may not be used to the TIMD, but used to a normal direction prediction mode, as an alternative or supplement to the normal direction prediction mode.

It should be noted that, although the steps of the method of this application are described in a particular order in the accompanying drawings, it is not required or implied that these steps must be performed in that particular order, or that all the steps shown must be performed to achieve the desired result. Additionally or alternatively, some steps may be omitted, multiple steps are combined into one step for execution, and/or one step is decomposed into multiple steps for execution, or the like. Alternatively, steps in different embodiments are combined into new technical solutions.

Based on the foregoing embodiments, an embodiment of this application provides a decoding apparatus, and the decoding apparatus is applied to a decoder. FIG. 18 is a schematic structural diagram of a decoding apparatus according to an embodiment of this application. As shown in FIG. 18, the decoding apparatus 18 includes: a first determining module 1801, a second determining module 1802, a third determining module 1803, a fourth determining module 1804 and a first prediction module 1805.

The first determining module 1801 is configured to determine a prediction cost of a candidate prediction mode of a current block according to a template of the current block.

The second determining module 1802 is configured to determine a first prediction mode of the current block according to the prediction cost.

The third determining module 1803 is configured to determine a reference template of the template according to the first prediction mode.

The fourth determining module 1804 is configured to determine a first model parameter according to the reference template and the template.

The first prediction module 1805 is configured to perform intra prediction on the current block according to the first prediction mode and the first model parameter, to obtain a predicted value of the current block.

In some embodiments, the first determining module 1801 is further configured to determine a template of the current block according to adjacent sample of the current block.

Further, in some embodiments, adjacent sample of the current block include at least one of the following:
an upper adjacent sample of the current block;
an upper-left adjacent sample of the current block;
an upper-right adjacent sample of the current block;
a left adjacent sample of the current block; or
a lower-left adjacent sample of the current block.

In some embodiments, the template of the current block includes available adjacent samples of the current block.

In some embodiments, the first determining module 1801 is further configured to determine a size of the template according to a size of the current block.

In some embodiments, the candidate prediction mode includes one or more prediction modes, and the prediction cost includes a prediction distortion value corresponding to the one or more prediction modes.

In some embodiments, the second determining module 1802 is further configured to determine the one or more prediction modes; perform intra prediction on the template according to the prediction mode to obtain a first predicted value; determining a prediction distortion value of the prediction mode for the template according to the first predicted value corresponding to the prediction mode and a first reconstruction value of the template.

In some embodiments, the process of determining the one or more prediction modes includes: determining the one or more prediction modes according to a second prediction mode used to perform intra prediction on adjacent blocks of the current block.

In some embodiments, the adjacent block includes at least one of the following:
a left adjacent block of the current block;
a lower-left adjacent block of the current block;
an upper-right adjacent block of the current block;
an upper adjacent block of the current block; or
an upper-left adjacent block of the current block.

In some embodiments, in a case that the second prediction mode includes no angular prediction mode, the one or more prediction modes include a Planar mode and/or a DC mode.

In some embodiments, in a case that the second prediction mod includes an angular prediction mode, the one or more prediction modes include a prediction mode in an MPM list of the current block constructed according to information of the adjacent block. The prediction mode may include a wide angle prediction mode.

In some embodiments, in a case that the MPM list includes no third prediction mode, the third prediction mode is added to the MPM list.

In some embodiments, the third prediction mode includes a DC mode, an HOR mode, and/or a VER mode.

In some embodiments, the first prediction mode is one or more prediction modes selected from the candidate prediction modes.

In some embodiments, the first prediction mode includes a prediction mode with a minimum prediction cost in the candidate prediction mode.

In some embodiments, the process of determining a reference template of the template according to the first prediction mode includes: determining a reference template of the template according to the prediction mode with a minimum prediction cost.

In some embodiments, the process of determining a first model parameter according to the reference template and the template includes: determining the first model parameter according to a sample reference value in the reference template and a sample reference value in the template.

In some embodiments, the process of determining the first model parameter according to the sample reference value of the reference template and the sample reference value of the template includes: determining an autocorrelation parameter according to the pixel reference value in the reference template; determining a cross-correlation parameter according to the sample reference value in the template and the sample reference value in the reference template; and determining the first model parameter according to the autocorrelation parameter and the cross-correlation parameter.

In some embodiments, if a part of input position of a target filtering model corresponding to the first model parameter exceeds the reference template or the template, the reference template or the template is filled with a sample reference value corresponding to the part of input position.

In some embodiments, the reference template or the template is filled with a sample reference value corresponding to the part of input location, if at least one of the following conditions is met:
a sample position corresponding to the part of input position is already reconstructed;
the part of input position does not exceed a boundary of a current image; or
the part of input position does not exceed a Tile boundary.

In some embodiments, when a part of input location of the target filtering model corresponding to the first model parameter exceeds the reference template, the part of the input location does not participate in determining the first model parameter.

In some embodiments, the sample reference value includes at least one of: a sample reconstruction value, a sample gradient value of the sample reconstruction value, and sample location information.

In some embodiments, the process of performing intra prediction on the current block according to the first prediction mode and the first model parameter to obtain a predicted value of the current block includes: performing intra prediction on the current block according to the prediction mode with a minimum prediction cost, to obtain a second predicted value; and performing filtering processing on the second predicted value according to the first model parameter to obtain a predicted value of the current block.

In some embodiments, if at least one of the following conditions is met, filtering processing is performed on the second predicted value according to the first model parameter to obtain a predicted value of the current block: the candidate prediction mode includes only a Planar mode and/or a DC mode; or the one or more candidate prediction modes include only one prediction mode.

In some embodiments, when the candidate prediction mode does not include only a Planar mode and/or a DC mode, and the candidate prediction mode includes multiple prediction modes, the first prediction mode includes a prediction mode with a minimum prediction cost and a prediction mode with a second minimum prediction cost, or the first prediction mode includes a prediction mode with a minimum prediction cost.

In some embodiments, the second minimum prediction cost indicates a second minimum among a first prediction cost and a second prediction cost. The minimum prediction cost indicates a minimum among the first prediction cost and the second prediction cost. The first prediction cost includes a prediction cost of the candidate prediction mode for the template; and the second prediction cost includes a prediction cost of an adjacent angle mode of prediction modes, for the template, in the candidate prediction mode with a minimum prediction cost and a second minimum prediction cost for the template.

In some embodiments, the second minimum prediction cost indicates a second minimum of prediction costs of the candidate prediction mode for the template. The minimum prediction cost indicates a minimum of prediction costs of the candidate prediction mode for the template.

In some embodiments, if the second minimum prediction cost is greater than or equal to a product of the minimum prediction cost and a first value, the first prediction mode includes a prediction mode with the minimum prediction cost, where the first value is greater than 1.

In some embodiments, the process of performing intra prediction on the current block according to the first prediction mode and the first model parameter to obtain a predicted value of the current block includes: performing intra prediction on the current block according to the prediction mode with a minimum prediction cost, to obtain a third predicted value; and performing filtering processing on the third predicted value according to the first model parameter to obtain a predicted value of the current block.

In some embodiments, if the second minimum prediction cost is less than a product of the minimum prediction cost and a first value, the first prediction mode includes a prediction mode with the minimum prediction cost and a prediction mode with the second minimum prediction cost, where the first value is greater than 1.

In some embodiments, the process of performing intra prediction on the current block according to the first prediction mode and the first model parameter to obtain a predicted value of the current block includes: performing intra prediction on the current block according to a prediction mode corresponding to a minimum prediction cost, to obtain a fourth predicted value; performing intra prediction on the current block according to the prediction mode corresponding to the second minimum prediction cost, to obtain a fifth predicted value; performing weighted fusion on the fourth predicted value and the fifth predicted value to obtain a sixth predicted value; and performing filtering processing on the sixth predicted value according to the first model parameter to obtain a predicted value of the current block.

In some embodiments, the process of performing intra prediction on the current block according to the first prediction mode and the first model parameter to obtain a predicted value of the current block includes: performing intra prediction on the current block according to a prediction mode corresponding to a minimum prediction cost, to obtain a fourth predicted value; performing intra prediction on the current block according to a prediction mode corresponding to the second minimum prediction cost, to obtain a fifth predicted value; performing filtering processing on the fourth predicted value according to the first model parameter to obtain a seventh predicted value; and/or performing filtering processing on the fifth predicted value according to the first model parameter to obtain an eighth predicted value; and performing weighted fusion on the fourth predicted value and the eighth predicted value, or performing weighted fusion on the seventh predicted value and the eighth predicted value, or performing weighted fusion on the seventh predicted value and the fifth predicted value, to obtain the predicted value of the current block.

In some embodiments, the first prediction module 1805 is further configured to perform filtering processing on the predicted value of the current block according to the first model parameter to obtain the predicted value of the current block.

In some embodiments, the decoding apparatus 18 further includes a decoding module configured to decode a bitstream to determine a prediction residual of the current block, and determine a reconstruction value of the current block according to the predicted value of the current block and the prediction residual of the current block.

In some embodiments, the first model parameter includes a filtering coefficient of a target filtering model.

In some embodiments, the filtering processing includes: determining a product of a filter coefficient of the target filtering model and a predicted value of a corresponding location; and setting a first output value of the target filtering model to be equal to a sum of n products, where n represents a quantity of filtering coefficients of the target filtering model, and n is a positive integer.

In some embodiments, the predicted value of the part of input position is equal to the corresponding pixel reconstruction value, if the part of input position of the target filtering model exceeds the current block.

In some embodiments, the predicted value of the part of input position is equal to the corresponding pixel reconstruction value, if at least one of the following conditions is met:
a sample position corresponding to the part of input position is already reconstructed;
the part of input position does not exceed a boundary of a current image; or
the part of input position does not exceed a Tile boundary.

In some embodiments, if the part of input position of the target filtering model exceeds the current block, the part of input position is not used as the output position of the target filtering model.

In some embodiments, the output value of the filtering processing is equal to the first output value of the target filtering model, or the output value of the filtering processing is equal to a sum of the first output value of the target filtering model and a first offset value.

In some embodiments, the first offset value is equal to a preset second value.

In some embodiments, the first prediction module 1805 is further configured to determine the first offset value according to sample reconstruction values corresponding to at least one filtering coefficient that is different from a location of the first output value of the target filtering model.

In some embodiments, the first model parameter includes a filtering coefficient of a target filtering model. The process of determining the first model parameter according to the reference template and the template includes: determining a first candidate filtering coefficient of the target filtering model according to a sample reference value of a first-type sample in the reference template and a sample reference value of a first-type sample in the template; determining a second candidate filtering coefficient of the target filtering model according to a sample reference value of a second-type sample in the reference template and a sample reference value of a second-type sample in the template; parsing a bitstream to obtain a first index value of a filtering coefficient of the target filtering model; and determining a filtering coefficient of a target filtering model from the first candidate filtering coefficient and the second candidate filtering coefficient according to the first index value.

In some embodiments, the first type of sample is a sample whose sample reference value is greater than or equal to an average value of the sample reference value of a template in which the sample is located. The second type of sample is a sample whose sample reference value is less than or equal to the average value of the sample reference value of a template in which the sample is located.

In some embodiments, the first model parameter includes a filtering coefficient of a target filtering model. The template includes at least one template sub-area, and the reference template includes at least one matching sub-template. A matching sub-template of the template sub-area is determined according to the first prediction mode. The process of determining the first model parameter according to the reference template and the template includes: determining a corresponding third candidate filtering coefficient according to the template sub-area and a corresponding matching sub-template; parsing a bitstream to obtain a first index value of a filtering coefficient of the target filtering model; and determining, according to the first index value, the filtering coefficient of the target filtering model from third candidate filtering coefficients corresponding to the at least one template sub-region.

In some embodiments, the first model parameter includes a filtering coefficient of a target filtering model. The process of determining the first model parameter according to the reference template and the template includes: determining filtering coefficients of multiple filtering models with different shapes according to the reference template and the template; parsing a bitstream to obtain a first index value of a filtering coefficient of the target filtering model; and determining the filtering coefficient of the target filtering model from the filtering coefficients of the multiple filtering models with different shapes according to the first index value.

In some embodiments, the decoding apparatus 18 further includes a decoding module configured to: parse a bitstream to determine a shape of the target filtering model and/or a quantity of filtering coefficients of the target filtering model, or parse a bitstream to determine a shape of the multiple filtering models with different shapes and/or a quantity of filtering coefficients of the target filtering model, or parse a bitstream to obtain first syntax identifier information and second syntax identifier information; and when the first syntax identifier information is equal to a third value and the second syntax identifier information is equal to a fourth value, performing intra prediction on the current block according to the first prediction mode and the first model parameter. The third value represents that intra prediction is performed on the current block by using an intra-frame mode derivation method based on a template, and the fourth value represents that intra prediction is performed on the current block by using the first model parameter.

In some embodiments, in a case that a first matching error between the reference template and the template is greater than or equal to a first threshold, intra prediction is performed on the current block according to the first prediction mode and the first model parameter. In a case that a second matching error between the reference template and the template subjected to filtering by using the first model parameter is greater than or equal to a second threshold, intra prediction is performed on the current block according to the first prediction mode and the first model parameter.

The foregoing description of the decoding apparatus embodiment is similar to the foregoing description of the encoding method embodiment, and has a beneficial effect similar to that of the encoding method embodiment. For technical details not disclosed in the embodiments of the decoding apparatus in this application, one may refer to the description in the embodiments of the encoding method in this application.

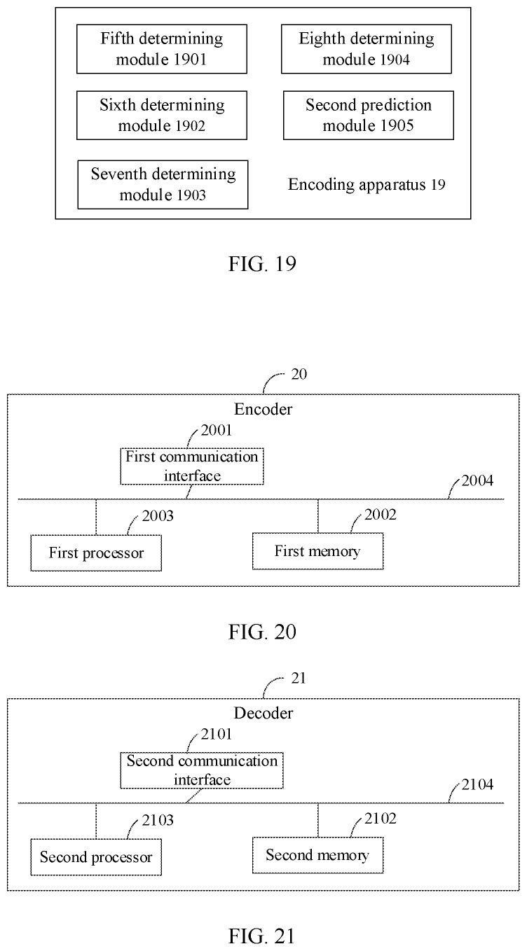

An embodiment of this application provides an encoding apparatus, and the encoding apparatus is applied to an encoder. FIG. 19 is a schematic structural diagram of an encoding apparatus according to an embodiment of this application. As shown in FIG. 19, the encoding apparatus 19 includes: a fifth determining module 1901, a sixth determining module 1902, a seventh determining module 1903, an eighth determining module 1904, and a second prediction module 1905.

The fifth determining module 1901 is configured to determine a prediction cost of the candidate prediction mode of the current block according to the template of the current block.

The sixth determining module 1902 is configured to determine a first prediction mode of the current block according to the prediction cost.

The seventh determining module 1903 is configured to determine a reference template of the template according to the first prediction mode.

The eighth determining module 1904 is configured to determine a first model parameter according to the reference template and the template.

The second prediction module 1905 is configured to perform intra prediction on the current block according to the first prediction mode and the first model parameter, to obtain a predicted value of the current block.

In some embodiments, the fifth determining module 1901 is further configured to determine the template of the current block according to adjacent samples of the current block.

In some embodiments, adjacent samples of the current block include at least one of the following:
an upper adjacent sample of the current block;
an upper-left adjacent sample of the current block;
an upper-right adjacent sample of the current block;
a left adjacent sample of the current block; or
a lower-left adjacent sample of the current block.

In some embodiments, the template of the current block includes available adjacent samples of the current block.

In some embodiments, the fifth determining module 1901 is further configured to determine a size of the template according to a size of the current block.

In some embodiments, the candidate prediction mode includes one or more prediction modes, and the prediction cost includes a prediction distortion value corresponding to the one or more prediction modes.

In some embodiments, the sixth determining module 1902 is further configured to: determine the one or more prediction modes; performing intra prediction on the template according to the prediction mode to obtain a first predicted value; and determining a prediction distortion value of the prediction mode for the template according to the first predicted value corresponding to the prediction mode and a first reconstruction value of the template.

In some embodiments, the process of determining the one or more prediction modes includes: determining the one or more prediction modes according to a second prediction mode used to perform intra prediction on adjacent blocks of the current block.

In some embodiments, the adjacent block includes at least one of the following:
a left adjacent block of the current block;
a lower-left adjacent block of the current block;
an upper-right adjacent block of the current block;
an upper adjacent block of the current block; or
an upper-left adjacent block of the current block.

In some embodiments, in a case that the second prediction mode includes no angular prediction mode, the one or more prediction modes include a Planar mode and/or a DC mode.

In some embodiments, in a case that the second prediction mod includes an angular prediction mode, the one or more prediction modes include a prediction mode in an MPM list of current blocks constructed according to the adjacent block information, and the prediction mode may include a wide angle mode.

In some embodiments, in a case that the MPM list includes no third prediction mode, the third prediction mode is added to the MPM list.

In some embodiments, the third prediction mode includes a DC mode, an HOR mode, and/or a VER mode.

In some embodiments, the first prediction mode is one or more prediction modes selected from the candidate prediction modes.

In some embodiments, the first prediction mode includes a prediction mode with a minimum prediction cost in the candidate prediction mode.

In some embodiments, the process of determining a reference template of the template according to the first prediction mode includes: determining a reference template of the template according to the prediction mode with a minimum prediction cost.

In some embodiments, the process of determining a first model parameter according to the reference template and the template includes: determining the first model parameter according to a sample reference value in the reference template and a sample reference value in the template.

In some embodiments, the process of determining the first model parameter according to the sample reference value of the reference template and the sample reference value of the template includes: determining an autocorrelation parameter according to the pixel reference value in the reference template; determining a cross-correlation parameter according to the sample reference value in the template and the sample reference value in the reference template; and determining the first model parameter according to the autocorrelation parameter and the cross-correlation parameter.

In some embodiments, when a part of the input position of the target filtering model corresponding to the first model parameter exceeds the reference template or the template, the reference template or the template is filled with a sample reference value corresponding to the part of input position.

In some embodiments, the reference template or the template is filled with a sample reference value corresponding to the part of input location, if at least one of the following conditions is met:
a sample position corresponding to the part of input position is reconstructed;
the part of input position does not exceed a boundary of a current image; or
the part of input position does not exceed a Tile boundary.

In some embodiments, when a part of input location of the target filtering model corresponding to the first model parameter exceeds the reference template, the part of input location does not participate in determining the first model parameter.

In some embodiments, the sample reference value includes at least one of a sample reconstruction value, a sample gradient value of the sample reconstruction value, and sample location information.

In some embodiments, the process of performing intra prediction on the current block according to the first prediction mode and the first model parameter to obtain a predicted value of the current block includes: performing intra prediction on the current block according to a prediction mode with a minimum prediction cost, to obtain a second predicted value; and performing filtering processing on the second predicted value according to the first model parameter to obtain a predicted value of the current block.

In some embodiments, in a case that at least one of the following conditions is met, filtering processing is performed on the second predicted value according to the first model parameter to obtain a predicted value of the current block:
the candidate prediction mode includes only a Planar mode and/or a DC mode; or
the one or more candidate prediction modes include only one prediction mode.

In some embodiments, when the candidate prediction mode does not include only a Planar mode and/or a DC mode, and the candidate prediction mode includes multiple prediction modes, the first prediction mode includes a prediction mode with a minimum prediction cost and a prediction mode with a second minimum prediction cost, or the first prediction mode includes a prediction mode with a minimum prediction cost.

In some embodiments, the second minimum prediction cost indicates a second minimum among a first prediction cost and a second prediction cost. The minimum prediction cost indicates a minimum among the first prediction cost and the second prediction cost. The first prediction cost includes a prediction cost of the candidate prediction mode for the template. The second prediction cost includes a prediction cost of an adjacent angle mode of prediction modes, for the template, in the candidate prediction mode with a minimum prediction cost and a second minimum prediction cost for the template.

In some embodiments, the second minimum prediction cost indicates a second minimum of prediction costs of the candidate prediction mode for the template. The minimum prediction cost indicates a minimum of prediction costs of the candidate prediction mode for the template.

In some embodiments, if the second minimum prediction cost is greater than or equal to a product of the minimum prediction cost and a first value, the first prediction mode includes a prediction mode with the minimum prediction cost. The first value is greater than 1.

In some embodiments, the process of performing intra prediction on the current block according to the first prediction mode and the first model parameter to obtain a predicted value of the current block includes: performing intra prediction on the current block according to the prediction mode with a minimum prediction cost, to obtain a third predicted value; and performing filtering processing on the third predicted value according to the first model parameter to obtain a predicted value of the current block.

In some embodiments, if the second minimum prediction cost is less than a product of the minimum prediction cost and a first value, the first prediction mode includes a prediction mode with the minimum prediction cost and a prediction mode with the second minimum prediction cost. The first value is greater than 1.

In some embodiments, the process of performing intra prediction on the current block according to the first prediction mode and the first model parameter to obtain a predicted value of the current block includes: performing intra prediction on the current block according to a prediction mode corresponding to a minimum prediction cost, to obtain a fourth predicted value; performing intra prediction on the current block according to the prediction mode corresponding to the second minimum prediction cost, to obtain a fifth predicted value; performing weighted fusion on the fourth predicted value and the fifth predicted value to obtain a sixth predicted value; and performing filtering processing on the sixth predicted value according to the first model parameter to obtain a predicted value of the current block.

In some embodiments, the performing intra prediction on the current block according to the first prediction mode and the first model parameter to obtain a predicted value of the current block includes: performing intra prediction on the current block according to a prediction mode corresponding to a minimum prediction cost, to obtain a fourth predicted value; and performing intra prediction on the current block according to a prediction mode corresponding to a second minimum prediction cost, to obtain a fifth predicted value; and performing filtering processing on the fourth predicted value according to the first model parameter to obtain a seventh predicted value; and/or performing filtering processing on the fifth predicted value according to the first model parameter to obtain an eighth predicted value; and performing weighted fusion on the fourth predicted value and the eighth predicted value, or performing weighted fusion on the seventh predicted value and the eighth prediction value, or performing weighted fusion on the seventh predicted value and the fifth predicted value, to obtain the predicted value of the current block.

In some embodiments, the second prediction module 1905 is further configured to perform filtering processing on the predicted value of the current block according to the first model parameter, to obtain the predicted value of the current block.

In some embodiments, the encoding apparatus 19 further includes an encoding module configured to determine a prediction residual of the current block according to the predicted value of the current block and an original value of the current block; and generating a bitstream according to the prediction residual of the current block.

In some embodiments, the first model parameter includes a filtering coefficient of a target filtering model.

In some embodiments, the filtering processing includes: determining a product of a filter coefficient of the target filtering model and a predicted value of a corresponding location; and setting a first output value of the target filtering model to be equal to a sum of n products, where n represents a quantity of filtering coefficients of the target filtering model, and n is a positive integer.

In some embodiments, if a part of input position of the target filtering model exceeds the current block, the predicted value of the part of input position is equal to a corresponding pixel reconstruction value.

In some embodiments, the predicted value of the part of input position is equal to the corresponding pixel reconstruction value, if at least one of the following conditions is met:
a pixel position corresponding to the part of input position is already reconstructed;
the part of input position does not exceed a boundary of a current image; or
the part of input position does not exceed a Tile boundary.

In some embodiments, the part of input position is not used as an output position of the target filtering model if the part of input position of the target filtering model exceeds the current block.

In some embodiments, the output value of the filtering processing is equal to a first output value of the target filtering model, or the output value of the filtering processing is equal to a sum of the first output value of the target filtering model and a first offset value.

In some embodiments, the first offset value is equal to a preset second value.

In some embodiments, the second prediction module 1905 is further configured to determine the first offset value according to a pixel reconstruction value corresponding to at least one filter coefficient different from a location of a first output value of the target filtering model.

In some embodiments, the first model parameter includes a filtering coefficient of a target filtering model. The process of determining the first model parameter according to the reference template and the template includes: determining a first candidate filtering coefficient of the target filtering model according to a sample reference value of a first-type sample in the reference template and a sample reference value of a first-type sample in the template; determining a second candidate filtering coefficient of the target filtering model according to a sample reference value of a second-type sample in the reference template and a sample reference value of a second-type sample in the template; and determining a filtering coefficient of the target filtering model according to the first candidate filtering coefficient and the second candidate filtering coefficient.

In some embodiments, the first type of sample is a sample whose sample reference value is greater than or equal to an average value of the sample reference value of a template in which the sample is located. The second type of sample is a sample whose sample reference value is less than or equal to the average value of the sample reference value of the template in which the sample is located.

In some embodiments, the first model parameter includes a filtering coefficient of a target filtering model, the template includes at least one template sub-area, and the reference template includes at least one matching sub-template, a matching sub-template of the template sub-area is determined according to the first prediction mode. The process of determining the first model parameter according to the reference template and the template includes: determining a third candidate filtering coefficient according to the template sub-area and a corresponding matching sub-template; and determining the filtering coefficient of the target filtering model according to the third candidate filtering coefficient corresponding to the at least one template sub-area.

In some embodiments, the first model parameter includes a filtering coefficient of a target filtering model. The process of determining the first model parameter according to the reference template and the template includes: determining filtering coefficients of multiple filtering models with different shapes according to the reference template and the template; and determining the filtering coefficient of the target filtering model according to the filtering coefficients of the multiple filtering models with different shapes.

In some embodiments, the encoding apparatus 19 further includes an encoding module, configured to: write a first index value of a filtering coefficient of the target filtering model into a bitstream, or write a shape of the target filtering model and/or a quantity of filtering coefficients of the target filtering model into a bitstream, or write a shape of the multiple filtering models with different shapes and/or a quantity of filtering coefficients of the target filtering model into a bitstream.

In some embodiments, in a case that a first matching error between the reference template and the template is greater than or equal to a first threshold, intra prediction is performed on the current block according to the first prediction mode and the first model parameter. In a case in which a second matching error between the reference template and the template subjected to filtering by using the first model parameter is greater than or equal to a second threshold, intra prediction is performed on the current block according to the first prediction mode and the first model parameter.

In some embodiments, the encoding apparatus 19 further includes an encoding module configured to: write first syntax identifier information and second syntax identifier information into a bitstream. In a case in which the first syntax identifier information is equal to a third value and the second syntax identifier information is equal to a fourth value, the third value represents that intra prediction is performed on the current block by using an intra-frame mode derivation method based on a template, and the fourth value represents that intra prediction is performed on the current block by using the first model parameter.

Descriptions of the foregoing encoding apparatus embodiments are similar to those of the foregoing encoding/decoding method embodiments, and the foregoing encoding apparatus embodiments have beneficial effects similar to those of the foregoing encoding/decoding method embodiments. For technical details that are not disclosed in the encoding apparatus embodiment of this application, one may refer to the description in the encoding/decoding method embodiments of this application.

It should be noted that module division of the encoding/decoding apparatus described in embodiments of this application is schematic, and is merely logical function division. In actual implementation, there may be another division manner. In addition, functional units in the embodiments of this application may be integrated into one processing unit, or may exist separately physically, or two or more units may be integrated into one unit. The foregoing integrated unit may be implemented in a form of hardware, or may be implemented in a form of a software functional unit, or may also be implemented in a form of a combination of software and hardware.

It should be noted that, in embodiments of this application, if the foregoing method is implemented in a form of a software function module, and is sold or used as an independent product, the method may also be stored in a computer readable storage medium. Based on such an understanding, the technical solutions in the embodiments of this application essentially, or the part contributing to the related technologies, may be implemented in a form of a software product. The computer software product is stored in a storage medium and includes several instructions for instructing the electronic device to execute all or a part of the methods in the embodiments of this application. The foregoing storage medium includes any medium that can store program code, such as a USB flash drive, a removable hard disk, a Read Only Memory (Read Only Memory, ROM), a magnetic disk, or an optical disc. In this way, embodiments of this application are not limited to any specific combination of hardware and software.

An embodiment of this application provides a computer readable storage medium, where the computer readable storage medium stores a computer program, and when the computer program is executed, the encoding method or the decoding method described in the embodiment of this application is implemented.

An embodiment of this application provides an encoder. As shown in FIG. 20, the encoder 20 includes a first communications interface 2001, a first memory 2002, and a first processor 2003. Each component is coupled together by using the first bus system 2004. It may be understood that the first bus system 2004 is configured to implement connection and communication between these components. In addition to a data bus, the first bus system 2004 further includes a power bus, a control bus, and a status signal bus. However, for clear description, various buses in FIG. 20 are marked as the first bus system 2004.

The first communications interface 2001 is configured to receive and transmit a signal in a process of transmitting and receiving information between the first communications interface 2001 and another external network element.

The first memory 2002 is configured to store a computer program runnable on the first processor 2003.

The first processor 2003 is configured to execute the encoding method in embodiments of this application when running the computer program.

It may be understood that the first memory 2002 in embodiments of this application may be a volatile memory or a non-volatile memory, or may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. By way of example rather than limitative description, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DRRAM). The first memory 2002 of the system and method described in this application is intended to include but is not limited to these and any other suitable type of memory.

The first processor 2003 may be an integrated circuit chip, and has a signal processing capability. In an implementation process, the steps in the foregoing methods may be completed by using an integrated logic circuit of hardware in the first processor 2003 or an instruction in a form of software. The foregoing first processor 2003 may be a general purpose processor, a Digital Signal Processor (DSP), an application-specific integrated circuit (ASIC), a Field Programmable Gate Array (FPGA) or another programmable logic device, a discrete gate or transistor logic device, or a discrete hardware component. The processor can implement or execute the methods, steps and logical block diagrams disclosed in embodiments of this application. The general-purpose processor may be a microprocessor, or the processor may be any conventional processor or the like. The steps of the methods disclosed with reference to embodiments of this application may be directly executed by a hardware decoding processor, or executed by a combination of hardware and software modules in the decoding processor. The software module may be located in a mature storage medium in the art, for example, a random access memory, a flash memory, a read-only memory, a programmable read-only memory, an erasable programmable memory, or a register. The storage medium is located in the first memory 2002. The first processor 2003 reads information in the first memory 2002 and completes the steps of the foregoing methods with reference to hardware of the first processor 2003.

It may be understood that these embodiments described in this application may be implemented by hardware, software, firmware, middleware, microcode, or a combination thereof. For hardware implementation, the processing unit may be implemented in one or more application-specific integrated circuits (ASIC), digital signal processors (DSP), digital signal processing devices (DSP Device, DSPD), programmable logic devices (PLD), field-programmable gate arrays (FPGA), general-purpose processors, controllers, microcontrollers, microprocessors, and other electronic units configured to execute the functions described in this application, or a combination thereof. For software implementation, the technologies described in this application can be implemented by modules (such as processes and functions) that execute the functions described in this application. Software code may be stored in a memory and executed by a processor. The memory can be implemented in the processor or outside the processor.

Optionally, in another embodiment, the first processor 2003 is further configured to execute any one of the foregoing coding method embodiments when running the computer program.

An implementation of this application provides a decoder. As shown in FIG. 21, the decoder 21 includes a second communications interface 2101, a second memory 2102, and a second processor 2103. Each component is coupled together by using a second bus system 2104. It may be understood that the second bus system 2104 is configured to implement connection and communication between these components. In addition to a data bus, the second bus system 2104 further includes a power bus, a control bus, and a status signal bus. However, for clear description, various buses are marked as the second bus system 2104 in FIG. 21.

The second communications interface 2101 is configured to receive and transmit a signal in a process of transmitting and receiving information with another external network element.

The second memory 2102 is configured to store a computer program runnable on the second processor 2103.

The second processor 2103 is configured to execute the decoding method in embodiments of this application when running the computer program.

It may be understood that a hardware function of the second memory 2102 is similar to that of the first memory 2002, and a hardware function of the second processor 2103 is similar to that of the first processor 2003. Details are not described herein.

An embodiment of this application further provides a bitstream, where the bitstream is obtained by using the foregoing encoding method.

An embodiment of this application provides an electronic device, including: a processor, configured to execute a computer program; and a computer readable storage medium, where the computer readable storage medium stores a computer program, and when the computer program is executed by the processor, the encoding method and/or the decoding method in embodiments of this application are implemented. The electronic device may be various types of devices that have a video encoding and/or decoding capability. For example, the electronic device is a mobile phone, a tablet computer, a notebook computer, a personal computer, a television, a projection device, or a surveillance device.

It should be noted herein that descriptions of the foregoing storage medium and device embodiments are similar to descriptions of the foregoing method embodiments, and the foregoing storage medium and device embodiments have beneficial effects similar to those of the method embodiments. For technical details not disclosed in the storage medium, and the device embodiments of this application, one may refer to the description in the method embodiments of this application.

It should be understood that “an embodiment” or “one embodiment” or “some embodiments” mentioned throughout the specification means that a specific feature, structure, or characteristic related to the embodiments is included in at least one embodiment of this application. Therefore, “in an embodiment” or “in one embodiment” or “in some embodiments” appearing throughout the specification does not necessarily refer to the same embodiment. In addition, these specific features, structures or characteristics may be incorporated in one or more embodiments in any suitable manner. It should be understood that in various embodiments of this application, a sequence number of the foregoing processes does not mean a sequence of execution. The execution sequence of the processes should be determined according to functions and internal logic of the processes, and should not constitute any limitation on an implementation process of the embodiments of this application. The foregoing sequence numbers of embodiments of this application are merely described, and do not represent advantages or disadvantages of the embodiments. The foregoing descriptions of the embodiments intend to emphasize differences between the embodiments. For a same or similar description, reference may be made to each other. For brevity, details are not described in this specification.

In this specification, the term “and/or” is merely an association relationship that describes an associated object, and indicates that three relationships may exist. For example, the object A and/or the object B may indicate that the object A exists separately, the object A and the object B exist simultaneously, and the object B exists separately.

It should be noted that in this specification, the term “include”, “comprise”, or any other variations thereof is intended to cover non-exclusive inclusion, so that a process, method, article, or apparatus that includes a series of elements includes not only those elements but also other elements that are not explicitly listed, or includes elements inherent to such a process, method, article, or device. In the absence of more restrictions, an element defined by the statement “includes a . . . ” does not exclude another same element in a process, method, article, or device that includes the element.

In the several embodiments provided in this application, it should be understood that the disclosed devices and methods may be implemented in another manner. The foregoing described embodiments are merely exemplary. For example, division of the modules is merely logical function division. In actual implementation, there may be another division manner. For example, multiple modules or components may be combined or integrated into another system, or some features may be ignored or not performed. In addition, the displayed or discussed components may be mutually coupled, or directly coupled, or communicatively connected by using some interfaces, or indirect coupling or communication connection between devices or modules, may be electrically, mechanically, or in another form.

The foregoing modules described as separate parts may or may not be physically separate, and parts displayed as modules may or may not be physical modules, may be located in one place or distributed on multiple network units. Some or all of the modules may be selected according to actual requirements to implement the objectives of the solutions of embodiments.

In addition, all functional modules in the embodiments of this application may be integrated into one processing unit, or each module may be separately used as one unit, or two or more modules may be integrated into one unit. The foregoing integrated module may be implemented in a form of hardware, or may be implemented in a form of hardware plus a software functional unit.

A person of ordinary skill in the art may understand that all or some of the steps of the foregoing method embodiments may be implemented by using hardware related to a program instruction, the foregoing program may be stored in a computer readable storage medium, and when being executed, the program performs the steps including the foregoing method embodiments. The foregoing storage medium includes any medium that can store program code, such as a mobile storage device, a Read Only Memory (ROM), a magnetic disk, or an optical disc.

Alternatively, if the integrated unit in this application is implemented in a form of a software function module and sold or used as an independent product, the integrated unit may also be stored in a computer readable storage medium. Based on such an understanding, the technical solutions in the embodiments of this application essentially, or the part contributing to the related technologies, may be implemented in a form of a software product. The computer software product is stored in a storage medium and includes several instructions for instructing the electronic device to execute all or a part of the methods in the embodiments of this application. The foregoing storage medium includes any medium that can store program code, such as a mobile storage device, a ROM, a magnetic disk, or an optical disc.

The disclosed methods provided in the several method embodiments of this application may be randomly combined with each other in the case of no conflicts, to obtain new method embodiments.

The disclosed features provided in the several product embodiments of this application may be randomly combined with each other in the case of no conflicts, to obtain new product embodiments.

The disclosed features provided in the several method or device embodiments of this application may be randomly combined with each other in the case of no conflicts, to obtain new method embodiments or device embodiments.

The foregoing descriptions are merely implementations of this application, but are not intended to limit the protection scope of this application. Any change or replacement readily figured out by a person skilled in the art within the technical scope disclosed in this application shall fall within the protection scope of this application. Therefore, the protection scope of this application shall be subject to the protection scope of the claims.

What is claimed is:

1. A decoding method, wherein the method is applied to a decoder, and the method comprises:
determining a prediction cost of a candidate prediction mode of a current block according to a template of the current block;
determining a first prediction mode of the current block according to the prediction cost;
determining a reference template of the template according to the first prediction mode; and
determining a first model parameter according to the reference template and the template; and
performing intra prediction on the current block according to the first prediction mode and the first model parameter, to obtain a predicted value of the current block.

2. The method according to claim 1, wherein the template of the current block comprises available adjacent samples of the current block.

3. The method according to claim 1, wherein the candidate prediction mode comprises one or more prediction modes, and the prediction cost comprises a prediction distortion value corresponding to the one or more prediction modes.

4. The method according to claim 3, further comprising:
determining the one or more prediction modes;
performing intra prediction on the template according to the prediction mode to obtain a first predicted value; and
determining a prediction distortion value of the prediction mode for the template according to the first predicted value corresponding to the prediction mode and a first reconstruction value of the template.

5. The method according to claim 4, wherein the determining the one or more prediction modes comprises:
determining the one or more prediction modes according to a second prediction mode used to perform intra prediction on an adjacent block of the current block.

6. The method according to claim 1, wherein the first prediction mode is one or more prediction modes selected from the candidate prediction mode.

7. The method according to claim 1, wherein the determining a first model parameter according to the reference template and the template comprises:
determining the first model parameter according to a sample reference value in the reference template and a sample reference value in the template.

8. The method according to claim 7, wherein the determining the first model parameter according to the sample reference value of the reference template and the sample reference value of the template comprises:
determining an autocorrelation parameter according to the sample reference value in the reference template;
determining a cross-correlation parameter according to the sample reference value in the template and the sample reference value in the reference template; and
determining the first model parameter according to the autocorrelation parameter and the cross-correlation parameter.

9. The method according to claim 6, wherein the performing intra prediction on the current block according to the first prediction mode and the first model parameter to obtain a predicted value of the current block comprises:
performing intra prediction on the current block according to the prediction mode with a minimum prediction cost, to obtain a second predicted value; and
performing filtering processing on the second predicted value according to the first model parameter to obtain a predicted value of the current block.

10. The method according to claim 6, wherein the performing intra prediction on the current block according to the first prediction mode and the first model parameter to obtain a predicted value of the current block comprises:
performing intra prediction on the current block according to a prediction mode corresponding to the minimum prediction cost, to obtain a fourth predicted value;
performing intra prediction on the current block according to a prediction mode corresponding to the second minimum prediction cost, to obtain a fifth predicted value;
performing weighted fusion on the fourth predicted value and the fifth predicted value to obtain a sixth predicted value; and
performing filtering processing on the sixth predicted value according to the first model parameter to obtain a predicted value of the current block.

11. The method according to claim 6, wherein the performing intra prediction on the current block according to the first prediction mode and the first model parameter to obtain a predicted value of the current block comprises:
performing intra prediction on the current block according to a prediction mode corresponding to the minimum prediction cost, to obtain a fourth predicted value;
performing intra prediction on the current block according to a prediction mode corresponding to the second minimum prediction cost, to obtain a fifth predicted value;
performing filtering processing on the fourth predicted value according to the first model parameter to obtain a seventh predicted value, and/or performing filtering processing on the fifth predicted value according to the first model parameter to obtain an eighth predicted value; and
performing weighted fusion on the fourth predicted value and the eighth predicted value, or performing weighted fusion on the seventh predicted value and the eighth predicted value, or performing weighted fusion on the seventh predicted value and the fifth predicted value, to obtain the predicted value of the current block.

12. The method according to claim 9, further comprising:
performing filtering processing on the predicted value of the current block according to the first model parameter to obtain the predicted value of the current block.

13. The method according to claim 9, wherein the filtering processing comprises:
determining a product of a filter coefficient of the target filtering model and a predicted value at a corresponding location; and
setting a first output value of the target filtering model to be equal to a sum of n products, wherein n represents a quantity of filtering coefficients of the target filtering model, and n is a positive integer.

14. The method according to claim 1, wherein the first model parameter comprises a filtering coefficient of a target filtering model;
wherein the determining the first model parameter according to the reference template and the template comprises:
determining a first candidate filtering coefficient of the target filtering model according to a sample reference value of a first-type sample in the reference template and a sample reference value of a first-type sample in the template;
determining a second candidate filtering coefficient of the target filtering model according to a sample reference value of a second-type sample in the reference template and a sample reference value of a second-type sample in the template;
parsing a bitstream to obtain a first index value of a filtering coefficient of the target filtering model; and
determining a filtering coefficient of the target filtering model from the first candidate filtering coefficient and the second candidate filtering coefficient according to the first index value.

15. The method according to claim 1, wherein the first model parameter comprises a filtering coefficient of a target filtering model, the template comprises at least one template sub-area, and the reference template comprises at least one matching sub-template, a matching sub-template of the template sub-area is determined according to the first prediction mode;
wherein the determining the first model parameter according to the reference template and the template comprises:
determining a third candidate filtering coefficient according to the template sub-area and a corresponding matching sub-template;
parsing a bitstream to obtain a first index value of a filtering coefficient of the target filtering model; and
determining, according to the first index value, the filtering coefficient of the target filtering model from the third candidate filtering coefficient corresponding to the at least one template sub-area.

16. The method according to claim 1, wherein the first model parameter comprises a filtering coefficient of a target filtering model;
wherein the determining the first model parameter according to the reference template and the template comprises:
determining filtering coefficients of a plurality of filtering models with different shapes according to the reference template and the template;
parsing a bitstream to obtain a first index value of the filtering coefficient of the target filtering model; and
determining the filtering coefficient of the target filtering model from the filtering coefficients of the plurality of filtering models with different shapes according to the first index value.

17. The method according to claim 7, further comprising:
parsing a bitstream to determine a shape of the target filtering model and/or a quantity of filtering coefficients of the target filtering model.

18. The method according to claim 16, further comprising:
parsing a bitstream to determine a shape of the plurality of filtering models with different shapes and/or a quantity of filtering coefficients of the target filtering model.

19. The method according to claim 1, wherein
a bitstream is parsed to obtain first syntax identifier information and second syntax identifier information;
when the first syntax identifier information is equal to a third value and the second syntax identifier information is equal to a fourth value, intra prediction is performed on the current block according to the first prediction mode and the first model parameter;
the third value represents that intra prediction is performed on the current block by using an intra-frame mode derivation method based on a template, and the fourth value represents that intra prediction is performed on the current block by using the first model parameter.

20. An encoding method, wherein the method is applied to an encoder, and the method comprises:
determining a prediction cost of a candidate prediction mode of a current block according to a template of the current block;
determining a first prediction mode of the current block according to the prediction cost;
determining a reference template of the template according to the first prediction mode;
determining a first model parameter according to the reference template and the template; and
performing intra prediction on the current block according to the first prediction mode and the first model parameter, to obtain a predicted value of the current block.

21. A non-transitory computer readable storage medium, storing a computer program/instruction and a bitstream, wherein the computer program/instruction is executed by a processor to implement the method according to claim 20 to generate the bitstream.
